(19) United States
(12) Patent Application Publication
(10) Pub. No.: US 2026/0111681 A1
(43) Pub. Date: Apr. 23, 2026

(54) Systems and Method for Structuring Analytical Conversations for Insight Extraction and Audience-Specific Summarization

(71) Applicant: Salesforce, Inc., San Francisco, CA (US)

(72) Inventors: Vidya Raghavan SETLUR, Portola Valley, CA (US); Srishti PALANI, Palo Alto, CA (US); Qi Kun GU, Seattle, WA (US); Philippe LABAN, Jersey City, NJ (US)

(21) Appl. No.: 19/019,351

(22) Filed: Jan. 13, 2025

Related U.S. Application Data
(60) Provisional application No. 63/710,479, filed on Oct. 22, 2024.

(51) Int. Cl. G06F 40/35; G06F 3/0482

(52) U.S. Cl. CPC G06F 40/35; G06F 3/0482

(57) ABSTRACT

Systems and methods for generating adaptable summaries at varying levels of detail are disclosed. In one aspect, a computer system, in response to receiving a user input specifying a dataset and a chat history of an analytical conversation associated with the dataset, extracts conversational components from the chat history. The computer system generates and displays a user interface and renders the conversational components as interactive affordances in one or more panels of the user interface. The computer system, in response to receiving a user interaction with a first interactive affordance, displays an editing panel in the user interface. The computer system receives a selection of content from the one or more panels and placement of the content in the editing panel. The computer system generates a summary of the analytical conversation according to the selected content and displays the summary in the user interface.

### RELATED APPLICATIONS

This application claims priority to U.S. Provisional Patent Application No. 63/710,479, filed Oct. 22, 2024, titled “SyncSense: Structuring Analytical Conversations for Effective Insight Extraction and Audience-Specific Summarization,” which is incorporated by reference herein in its entirety.

### TECHNICAL FIELD

The disclosed embodiments relate generally to data analysis and more specifically to systems, methods, and user interfaces for structuring analytical conversations for effective insight extraction and generating audience-specific summaries.

### BACKGROUND

Data-related tasks often involve analysis, collaboration, and sharing among different users. Chat-based interfaces are increasingly used for data exploration and analysis. However, these interfaces often lack features to synthesize critical insights during data exploration, hindering the ability to extract and share key findings efficiently.

### SUMMARY

Data-related tasks can span from problem definition to data collection, analysis, communication, and decision-making. Data-related tasks often involve collaboration and information-sharing among different users.

With the development of artificial intelligence (AI) models such as large language models (LLMs), AI chat assistants (e.g., chatbots) are becoming increasingly prevalent. AI chat assistants are computer programs designed to simulate human-like conversations, often using natural language processing (NLP) and machine learning (ML) techniques. AI chat assistants can be applied to facilitate user exploration of, interactions with, and analyses of data. For example, after uploading their data, a user can converse with an AI chat assistant to clean, shape, and transform the data. In some instances, the AI chat assistant can also build visualizations and answer data-driven questions. The benefits of applying AI chat assistants to data-related tasks include (i) lowering barriers to conducting data analysis (ii) making data-related accessible to people with little or no coding experience, (iii) saving time by allowing users to start more quickly by expressing broad, high-level intents, which can then be refined through ongoing conversation with the AI assistant; and (iv) enabling users to externalize their intentions and assumptions and preserving the provenance of their analytical steps, which are often hidden or lost in tools like computational notebooks.

Despite the benefits of AI chatbots, current chat-based interfaces tend to lack essential features of data analysis tools to support sharing. At the present, analyses are often shared as a static history of the entire conversation, which can be long, repetitive, and unstructured, with no concise summary of the key analytical insights to share with an intended audience. Critically, these shared artifacts do not support the varied information-seeking and sense-making needs of consumers of these analyses. Consequently, important insights can may be obscured, and the process of sharing analysis results becomes time-consuming and inefficient.

Current AI conversational platforms also perform poorly when it comes to extracting key information or tailoring summaries for different audiences such as technical experts or business decision-makers. Different groups of users tend to require different levels of detail from the data analysis. Some users may want to continue, repurpose, or reuse the analysis, which require certain technical details, while other users may want to quickly make decisions and identify key takeaways based on the analyses. To support these different needs, different components of the conversation need to be emphasized. In other words, there is a need to summarize the analytical conversation - including the visualizations, text, and code - at different levels of detail and abstraction. Current conversational AI platforms fall short in terms of extracting and sharing insightful results across diverse audiences and formats.

Accordingly, there is a need for tools that support sharing of analytical conversations in a structured manner. There is also a need for tools that facilitate the generation of audience-specific summaries of analytical conversations at varying levels of detail.

Some embodiments of the present disclosure address the limitations of current AI conversational platforms, by implementing a system - also referred to herein as SyncSense—that is configured to generate adaptable summaries at varying levels of detail. As disclosed, in some embodiments, SyncSense leverages large language models (LLMs) by identifying components within an analytical conversation that can be summarized and shared efficiently. SyncSense is configured to structure conversations into components such as conversation turns, insights, and artifacts. These components are dynamically extracted from the conversation, allowing users to interact with and explore the content in a structured way. For instance, a conversation turn might represent a user's query and the AI's response, which can include artifacts like visualizations, code, data tables, or insights (critical data points derived during the analysis), are also extracted and categorized for easy access and navigation.

In some embodiments, to help users manage complex conversations (e.g., conversations with many turns, nested topics or different artifacts), SyncSense provides an interface that synchronizes different views of the conversation across multiple levels of abstraction. For example, users can navigate a high-level timeline that shows the sequence of conversation turns, or they can dive deeper into a more detailed view that focuses on insights and associated artifacts. The system allows filtering by speech act (e.g., data comparison, fact-finding) or artifact type (e.g., code, visualizations), making it easy to locate specific parts of the conversation. This flexibility ensures that different audiences, ranging from technical experts to business decision-makers, can interact with the conversation at the level of detail that suits their needs. SyncSense also preserves provenance, meaning that all summary components retain a link back to their original context within the conversation. This is particularly important for verifying insights or tracing how conclusions were reached during an analysis. The provenance feature is integrated into the system's navigation, so users can click on a summary element and be taken directly to the corresponding section of the original conversation. SyncSense is also configured to present data insights to a wide range of audiences (e.g., technical and non-technical) while customizing the content to specific user needs.

As disclosed, the technical advantages of SyncSense over current AI chat platforms and content summarization tools include (1) enhanced ability for a user to efficiently navigate, explore, and share conversational insights; (2) time savings in terms of time spent on manually crafting summaries and reviewing lengthy conversation logs, more efficient workflows for different target audiences; (3) reduced cognitive load on users; (4) simplifying the process of continuing, reusing, or repurposing ongoing analyses; (5) enabling users to make faster and more informed decisions, by quickly identifying the most important insights from a conversation, improving data-driven decision-making processes. This streamlined workflow helps team members contribute more effectively without needing to sift through irrelevant or repetitive information.

The systems, methods, and user interfaces of this disclosure each have several innovative aspects, no single one of which is solely responsible for the desirable attributes disclosed herein.

In accordance with some embodiments, a method for generating adaptable data summaries is performed at a computer system that includes one or more processors and memory. The method includes receiving first user input specifying a dataset and a chat history of an analytical conversation associated with the dataset. The method includes, in response to receiving the first user input: (1) extracting a plurality of conversational components from the chat history, the plurality of conversational components including a plurality of: (i) one or more conversation turns, (ii) one or more speech acts; (iii) one or more analysis artifacts, (iv) one or more data insights, and (v) one or more conversation threads; (2) generating and displaying a user interface, including rendering the plurality of conversational components as interactive affordances in one or more panels of the user interface; (3) receiving a second user input, including a user interaction with a first interactive affordance in the one or more panels of the user interface; (4) in accordance with receiving the second user input, displaying an editing panel in the user interface while concurrently displaying the one or more panels of the user interface; (5) receiving a user interaction that includes selection of content from the one or more panels of the user interface and placement of the content in the editing panel of the user interface; (6) generating a summary of the analytical conversation according to the selected content; and (7) displaying the summary in the user interface.

In some embodiments, extracting the plurality of conversational components from the chat history includes applying a machine learning model to analyze conversation turns in the chat history of analytical conversation to dynamically extract the plurality of conversational components.

In some embodiments, extracting the plurality of conversational components from the chat history includes applying a set of criteria to analyze the chat history of analytical conversation to dynamically extract the plurality of conversational components.

In some embodiments, rendering the plurality of conversational components includes arranging the interactive affordances in the one or more panels of the user interface according to an order in which the conversational components corresponding to the interactive affordances occur in the analytical conversation.

In some embodiments, the chat history of the analytical conversation includes multiple conversation turns. The one or more panels of the user interface include a chat timeline panel having a plurality of rows, each row representing a respective conversation turn.

In some embodiments, the one or more panels of the user interface include a chat timeline panel and an analytical chat contents panel. The method includes, in response to receiving user selection of a second interactive affordance in the chat timeline panel, displaying a second conversational component corresponding to the second interactive affordance in the analytical chat contents panel while continuing to display the chat timeline panel.

In some embodiments, the one or more panels of the user interface include an analytical chat contents panel. Generating and displaying the user interface includes generating and displaying the analytical chat contents panel, including displaying a plurality of user-selectable headings on the analytical chat contents panel, each of the headings (i) corresponding to a respective conversation thread group and (ii) including a respective subset of the plurality of conversational components.

In some embodiments, the one or more panels of the user interface include an original chat panel. Generating and displaying the user interface includes displaying raw contents of the chat history in the original chat panel.

In some embodiments, generating the summary of the analytical conversation according to the selected content includes: (i) serializing the content into a markdown string; (ii) inputting the markdown string into a language model application; and (iii) receiving from the language model application the summary of the analytical conversation.

In some embodiments, the method further includes saving the summary of the analytical conversation as a first version.

In some embodiments, the method further includes generating multiple summaries of the analytical conversation over time, by selecting respective content each time, where each summary of the multiple summaries is associated with a different version.

In some embodiments, the method further includes after displaying the summary of the analytical conversation in the user interface, receiving a third user input, and in accordance with receiving the third user input, exporting the summary to an application. In some embodiments, the application can include a messaging application such as Slack®, an email application, email, a data presentation/communication application such as Microsoft PowerPoint®, Tableau Software®, Microsoft PowerBI®, or a reporting software application.

In accordance with some embodiments, a computer system includes one or more processors and memory coupled to the one or more processors. The memory stores one or more programs configured for execution by the one or more processors. The one or more programs include instructions for performing any of the methods disclosed herein.

In accordance with some implementation, a non-transitory computer readable storage medium stores one or more programs configured for execution by a computer system having one or more processors, and memory. The one or more programs include instructions for performing any of the methods disclosed herein.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Detailed Description of Embodiments below, in conjunction with the following drawings in which like reference numerals refer to corresponding parts throughout the figures.

FIG. 1 illustrates a workflow for generating adaptable summaries from an analytical conversation via SyncSense, in accordance with some embodiments.

FIG. 2 provides a block diagram of a computing device, in accordance with some embodiments.

FIG. 3 provides a block diagram of a server system, in accordance with some embodiments.

FIG. 4 illustrates the components of an analytical conversation, in accordance with some embodiments.

FIG. 5 illustrates definitions and examples of different speech act categories, in accordance with some embodiments.

FIGS. 6A, 6B-1, 6B-2, and 6C illustrate various views of the SyncSense user interface, in accordance with some embodiments.

FIGS. 7A and 7B is an example prompt that is input by a computer system executing SyncSense into data processing models to extract speech acts, in accordance with some embodiments.

FIGS. 8A to 8D is an example prompt that is input by a computer system executing SyncSense into data processing models to extract data insights from analytical conversations, in accordance with some embodiments.

FIGS. 9A to 9C are example prompts that are input by a computer system executing SyncSense into data processing models to iteratively extract conversation threads, in accordance with some embodiments.

FIGS. 10A and 10B illustrate an example prompt that is input by a computer system executing SyncSense into data processing models to summarize analytical conversations, in accordance with some embodiments.

FIGS. 11A to 11B are screenshots illustrating user interactions with an AI chat platform, in accordance with some embodiments.

FIGS. 12A to 12Z are screenshots illustrating user interactions with SyncSense, in accordance with some embodiments.

FIGS. 13A to 13G provide a flowchart of a method for generating adaptable data summaries, in accordance with some embodiments.

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DETAILED DESCRIPTION OF EMBODIMENTS

Some embodiments of the present disclosure are directed to systems, methods, and user interfaces that enable users to craft audience-specific summaries of analytical conversations through synchronized extracted chat contents at different granularities of detail. An analytical conversation is a dialogue-driven process where a user (or multiple users) interacts with a system/tool to explore, interpret, and derive insights from data. Analytical conversations are unique for summarization due to their insight-driven content, where the goal is to uncover facts, patterns, or anomalies. Analytical conversations frequently involve mixed modalities, integrating natural language, visualizations, and code snippets, all of which must be synthesized coherently in a summary. Analytical conversations are typically iterative and non-linear, with users refining queries, revisiting previous points, and exploring multiple analysis paths. Effective summarization must preserve the provenance of insights, allowing users to trace back conclusions to their original context, such as queries or datasets. Additionally, summaries must adapt to different audiences, offering technical details for analysts and high-level takeaways for business stakeholders. These conversations also serve as cognitive scaffolding, externalizing thought processes and assumptions that need to be captured to provide context for decisions. In addition, insights are often temporally dependent, building upon previous steps, so summaries must preserve this flow and contextual linkage.

The disclosed system and user interface, also known as SyncSense, enables an intuitive drag-and-drop summary editing experience. In accordance with some embodiments, a computer system that includes one or more processors and memory is configured for generating adaptable data summaries (e.g., by executing SyncSense). The computer system receives first user input specifying a dataset (e.g., data source, a CSV file) and a chat history (e.g., chat log) of an analytical conversation associated with the dataset. In some embodiments, the chat history includes a record of all messages regarding the dataset sent and received in a chat session between a user and a chat application. In some embodiments, the first user input specifying the chart history includes user specification of a link (e.g., a URL) to the chat history. In some embodiments, the chat history is a chat log between the user and a chatbot. In some embodiments, the chatbot is an AI chat or a LLM-based chat assistant such as ChatGPT®. The computer system, in response to receiving the first user input, extracts (or causes to be extracted) a plurality of conversational components from the chat history. The plurality of conversational components includes a plurality of: conversation turns (e.g., turn pairs), speech acts, analysis artifacts (e.g., code, visualizations, table, or execution output), data insights (e.g., numerical or statistical results derived from data in the dataset and/or chat history), and conversation threads and/or conversation sub-threads. The computer system generates and displays a user interface, including rendering the plurality of conversational components as interactive affordances (e.g., interactive icons that a user can select or hover over) in one or more panels of the user interface. In some embodiments, the one or more panels include a chat timeline panel. In some embodiments, the one or more panels include an analytical chat contents panel. In some embodiments, the one or more panels include an original chat panel. The computer system receives a second user input that includes a user interaction with a first interactive affordance in the one or more panels of the user interface. The computer system, in accordance with receiving the second user input, displays an editing panel in the user interface while concurrently displaying the one or more panels of the user interface. The computer system receives a user interaction that includes selection of content from the one or more panels of the user interface and placement of the content in the editing panel of the user interface (e.g., via a drag and drop action). The computer system generates a summary of the analytical conversation according to the selected content, and displays the summary in the user interface.

In accordance with some embodiments, the design of SyncSense is informed by the following design goals (DG):

DG1: Surface conversation components across the interface. Effective scaffolding of the conversation is crucial for supporting navigation, information-seeking, and creating a shared language for summary content. Additionally, abstractions of the raw conversation can assist summary writers in reviewing chat content. Therefore, the tool should treat conversation components (see section on “Components of an Analytical Conversation”) as first-class interactive units, providing intuitive and consistent visual indicators for these elements.

DG2: Enable a quick overview of the conversation structure. Chat navigation is a common issue with modern chat interfaces. This issue is further exacerbated in analytical conversations with artifacts and interleaved threads. Therefore, consumers should be able to obtain a quick high-level overview of different aspects of the analysis conversation. Specifically, in retrospectively viewing the conversation and constructing analysis summaries, the overview should highlight all the core components in a conversation.

DG3: Support filtering and multiple views of the conversation. Users have a range of user intents, ranging from understanding key takeaways and insights, the relevant context, the associated analysis threads (i.e., the analytical processes), or additional information needed for verification. For example, a user may only want to focus on certain queries or specific artifacts. The tool should provide filtering options for the conversation content that allows users to customize their view of the conversation based on their interests.

DG4: Support expandable navigation of the summary. Content expansion should be guided by the users'information needs. Therefore, when engaging in data conversations, the details from sub-threads, user queries, code, or visualizations, etc., should be readily available upon request.

DG5: Maintain the provenance and attribution of abstracted content. For an LLM-powered tool, it is crucial that the abstracted and extracted content accurately reflects the original raw conversation. Additionally, it is essential to clarify the content that contributed to an AI-generated summary.

DG6: Support authoring directly from conversation components. To easily allow users to author summaries and adapt the content of summaries depending on target audience or medium, users should be able to intuitively construct summaries from the conversation components.

DG7: Clearly differentiate LLM generated and non-LLM generated content. Previous research has shown that AI-powered systems that lack a clear distinction between LLM-generated and non-LLM-generated content can hinder users'ability to trust and understand the interface. Users of the summaries should be able to clearly understand which UI components originate from the original conversation and which are generated by the AI. To improve the usability of SyncSense, it is crucial to clearly differentiate between these types of content.

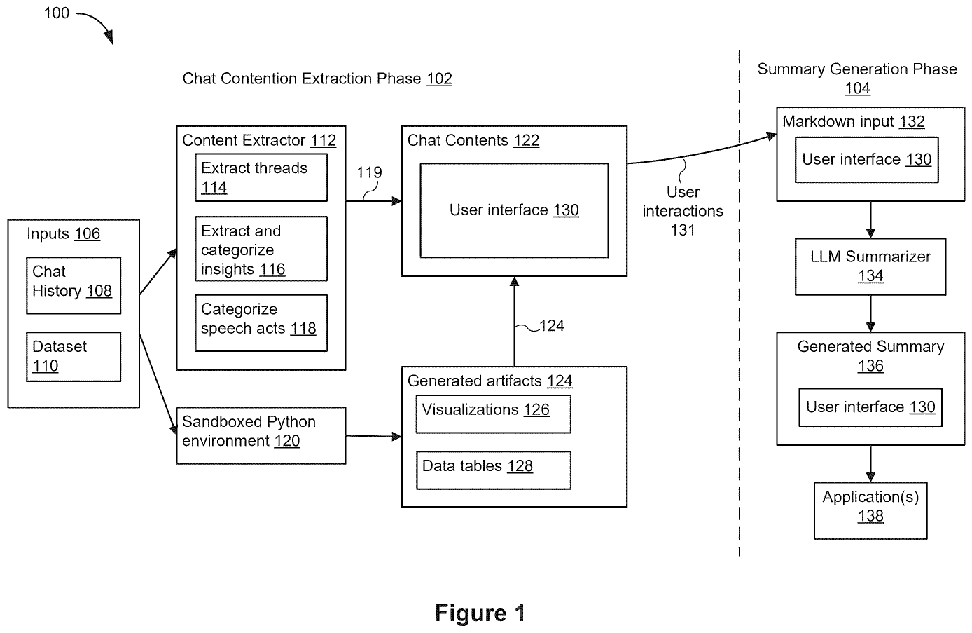

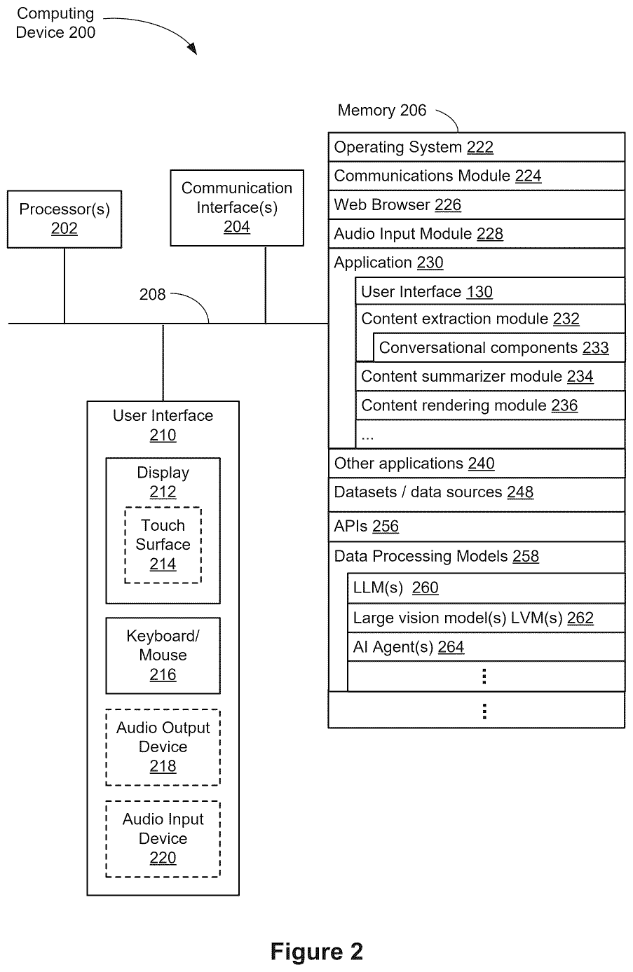

FIG. 1 illustrates a workflow 100 for generating adaptable summaries from an analytical conversation via SyncSense, in accordance with some embodiments.

The workflow 100 includes a chat content extraction phase 102 and a summary generation phase 104.

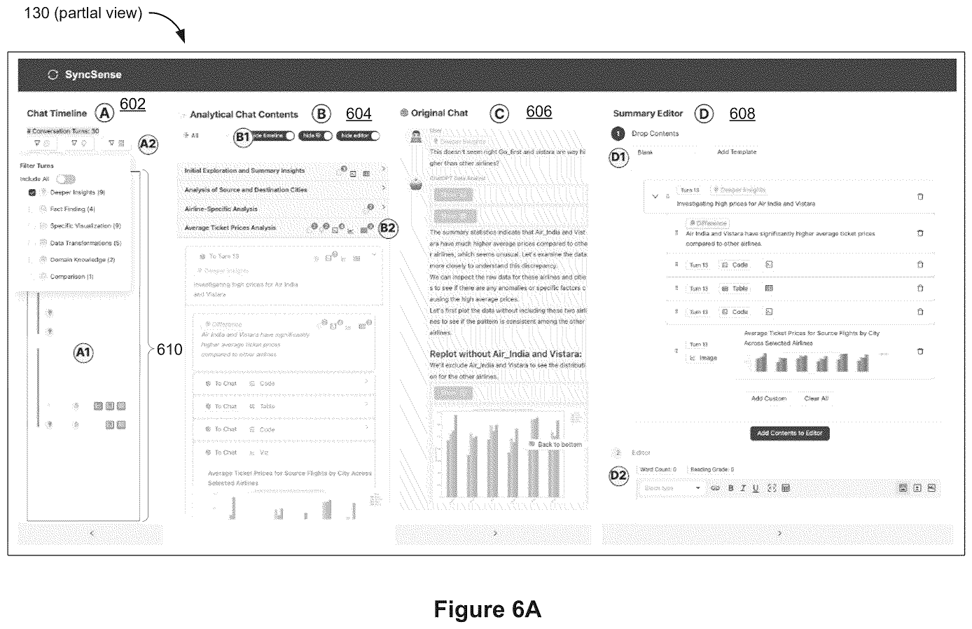

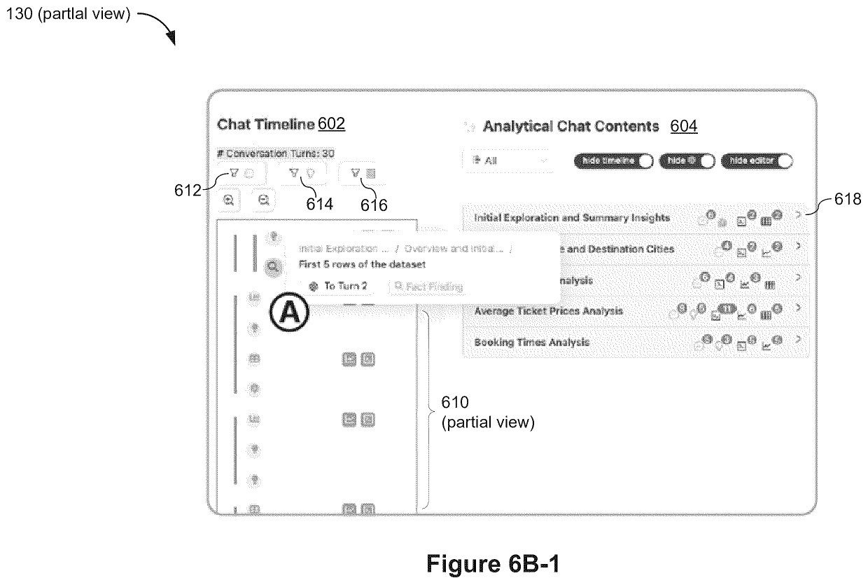

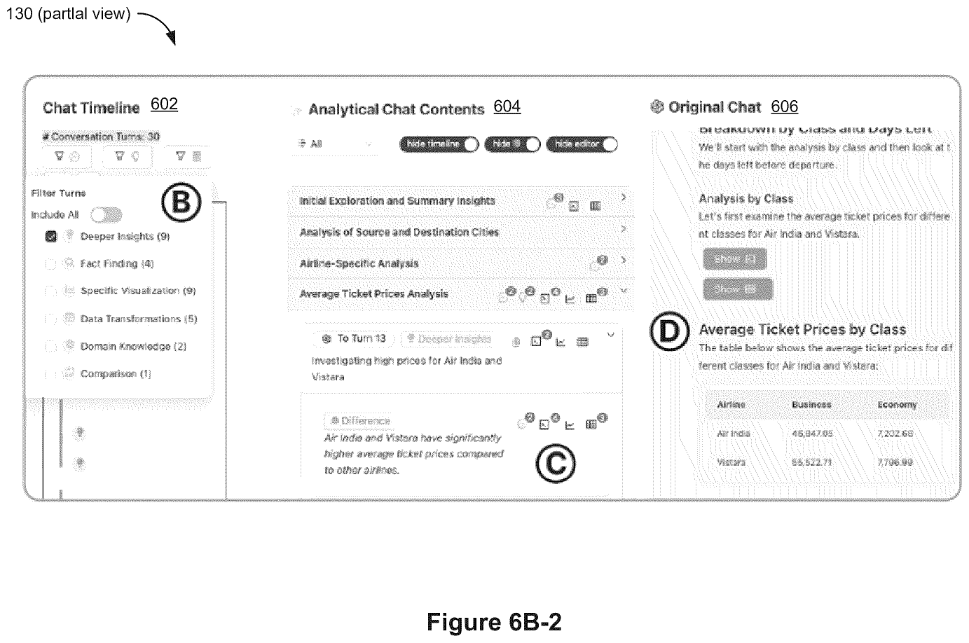

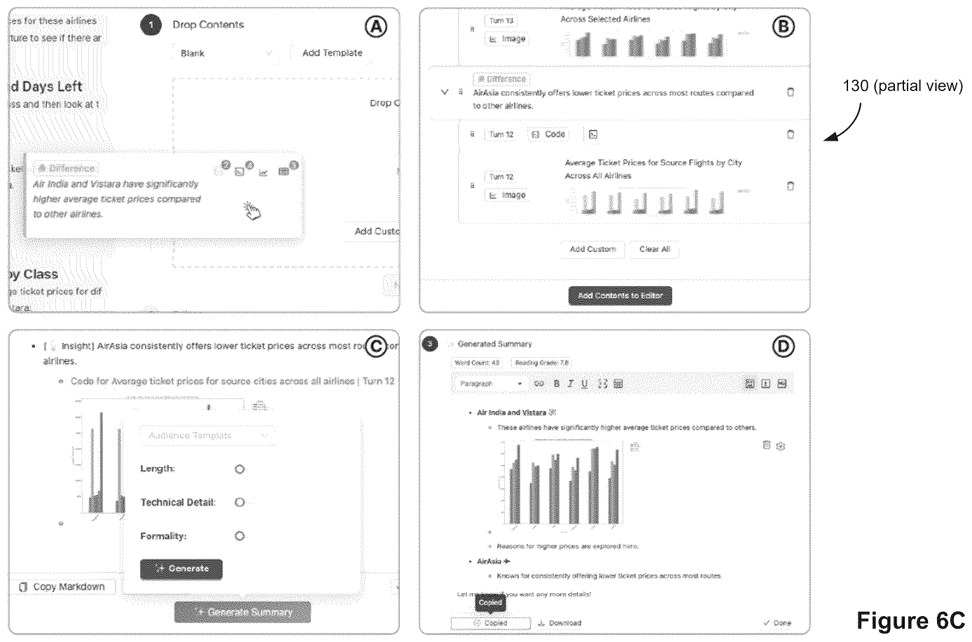

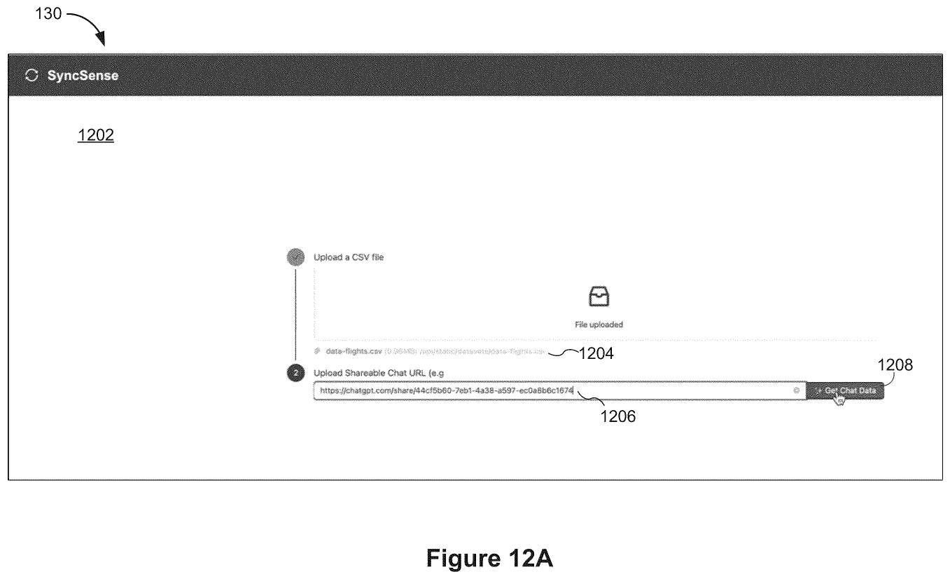

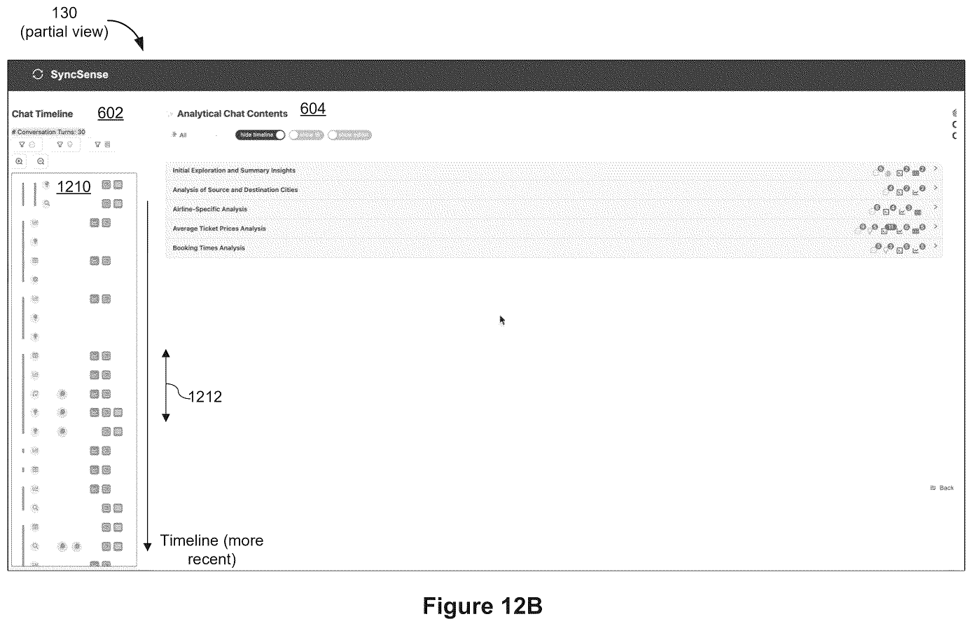

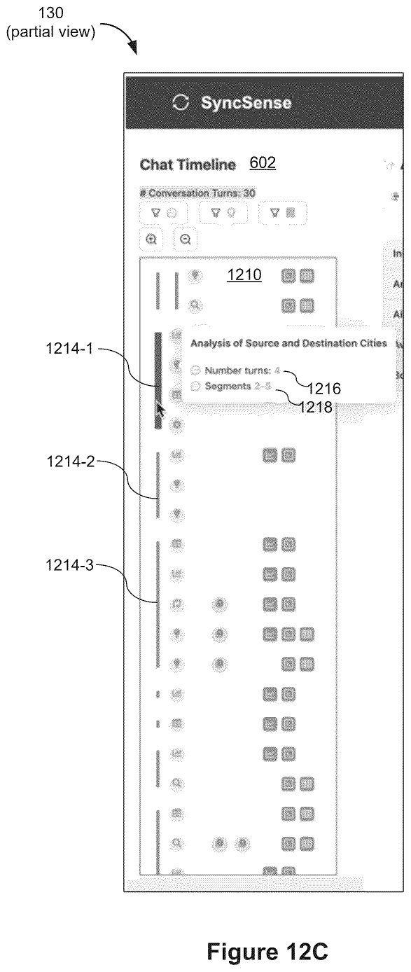

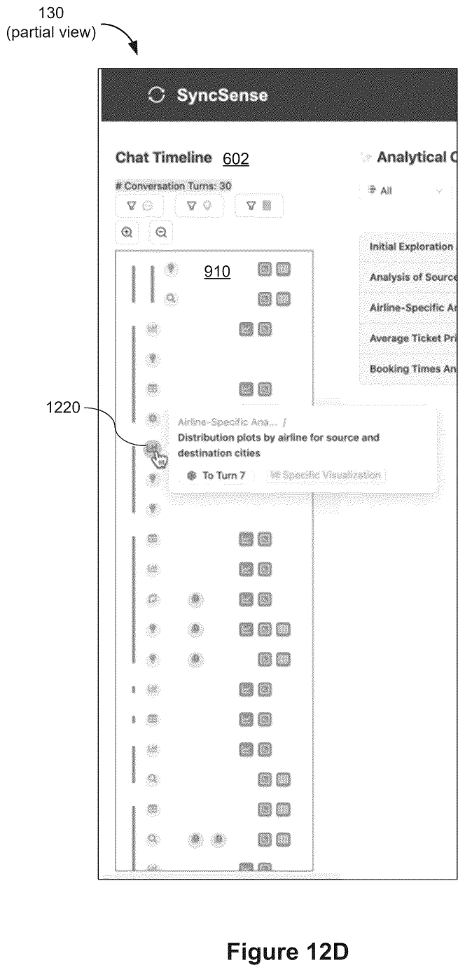

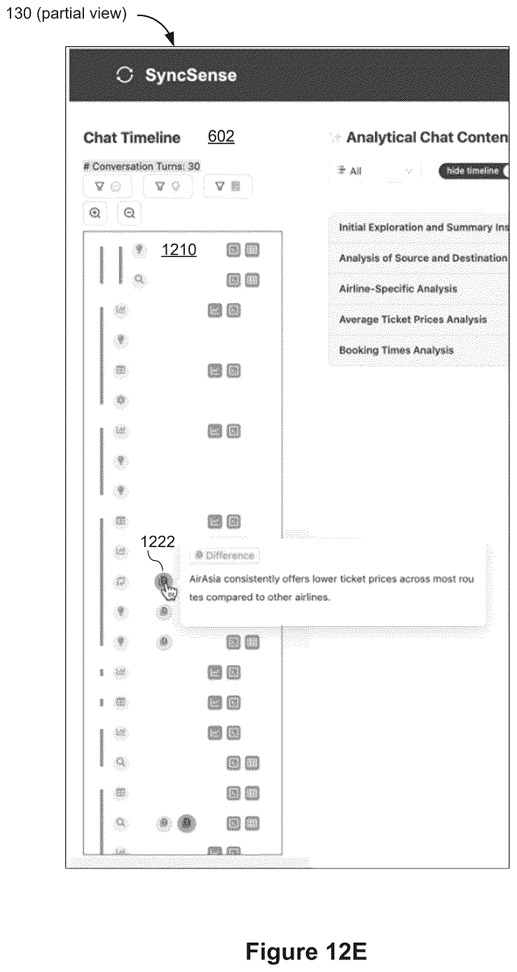

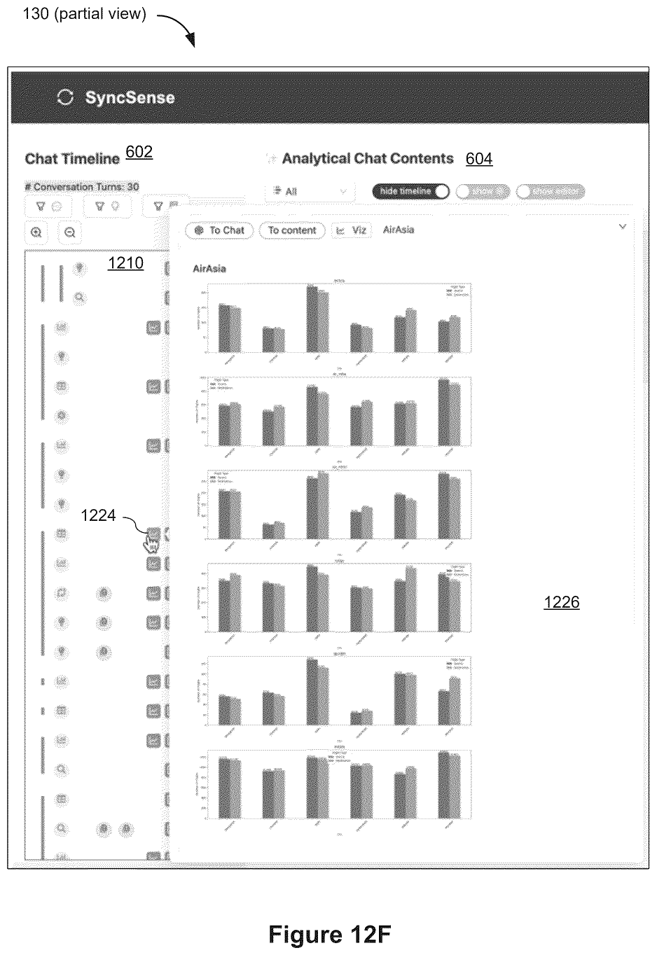

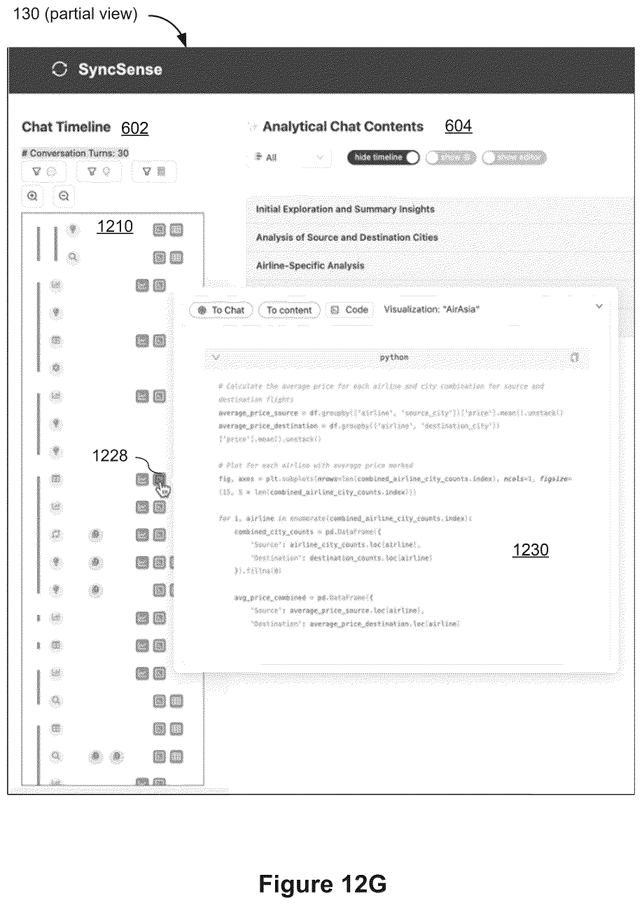

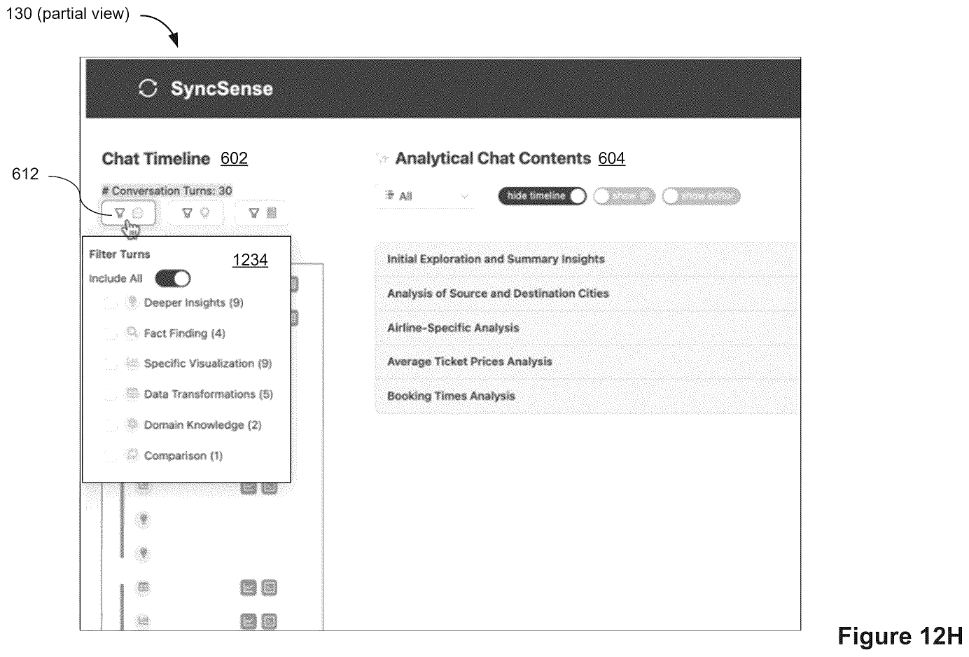

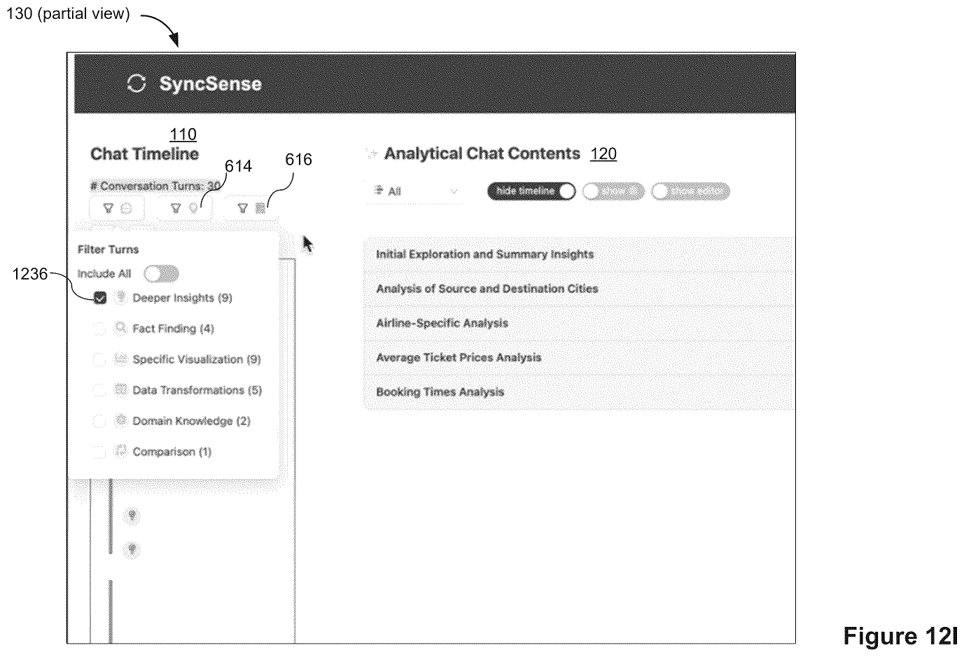

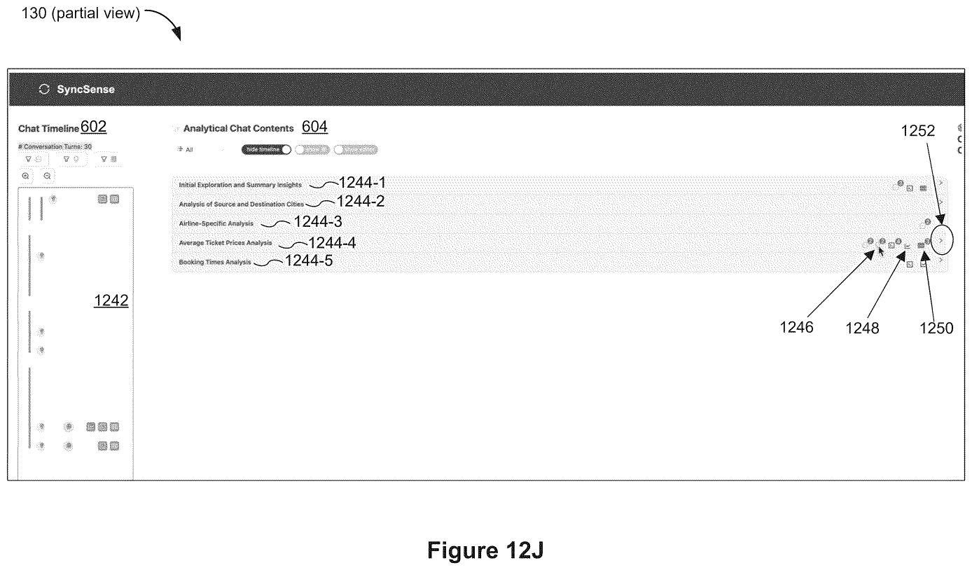

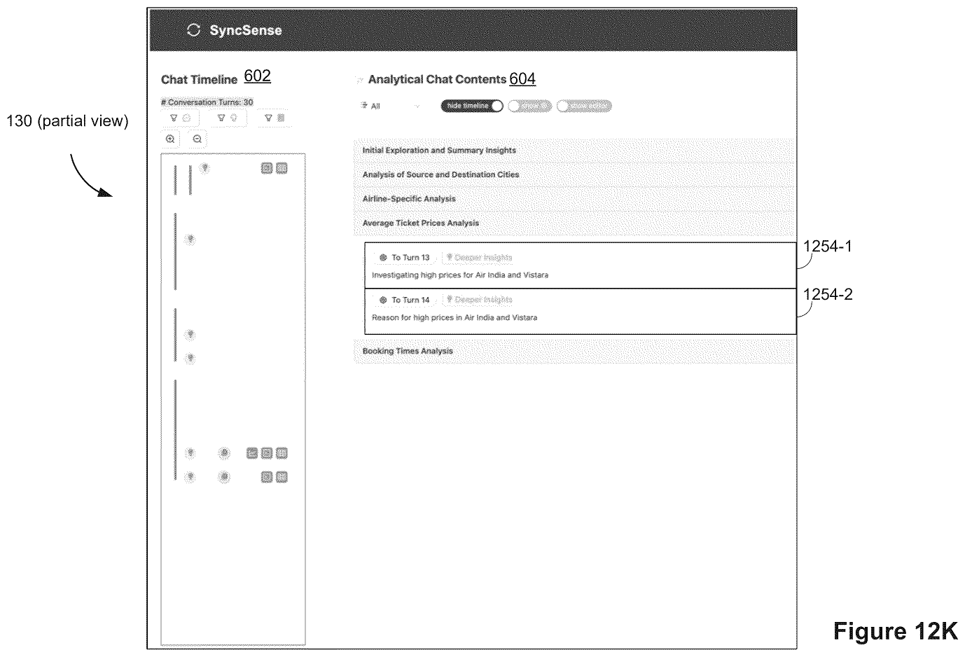

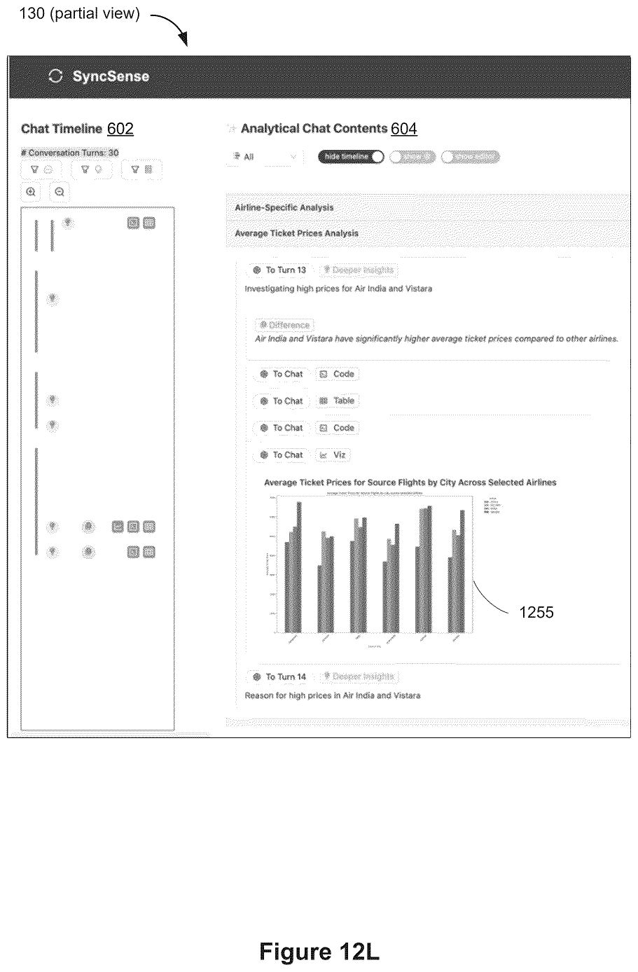

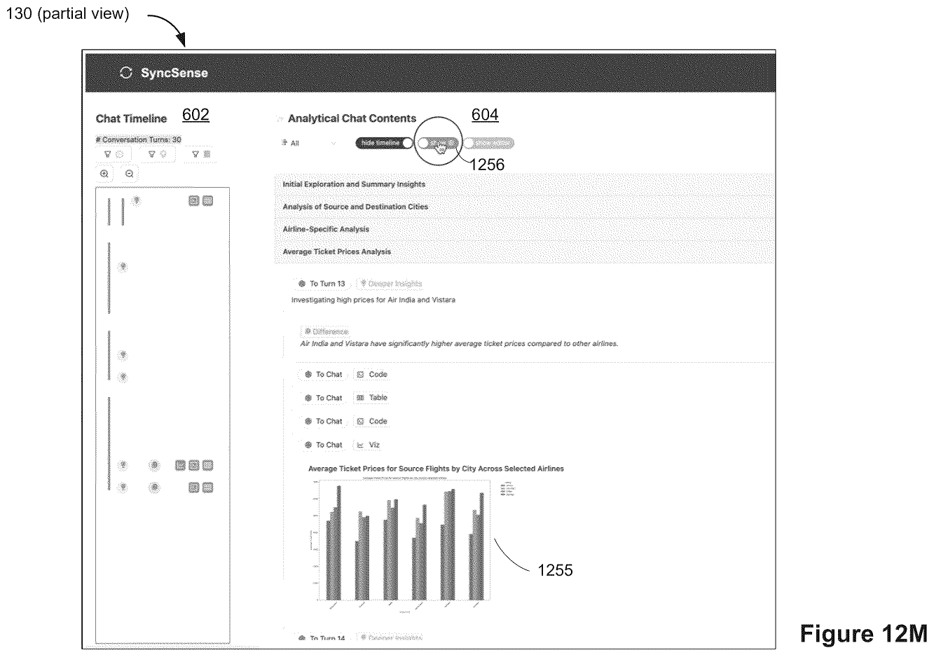

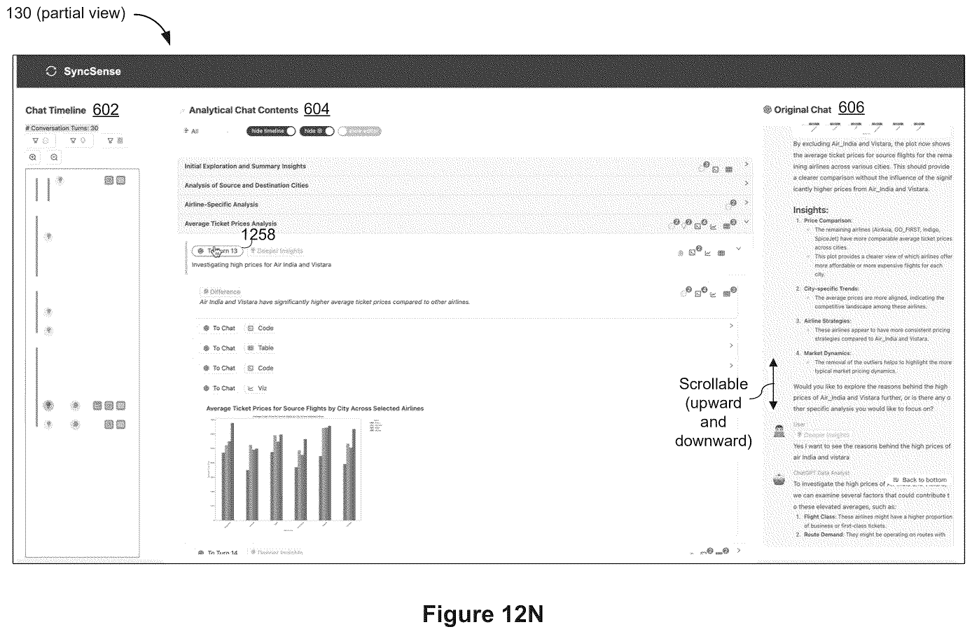

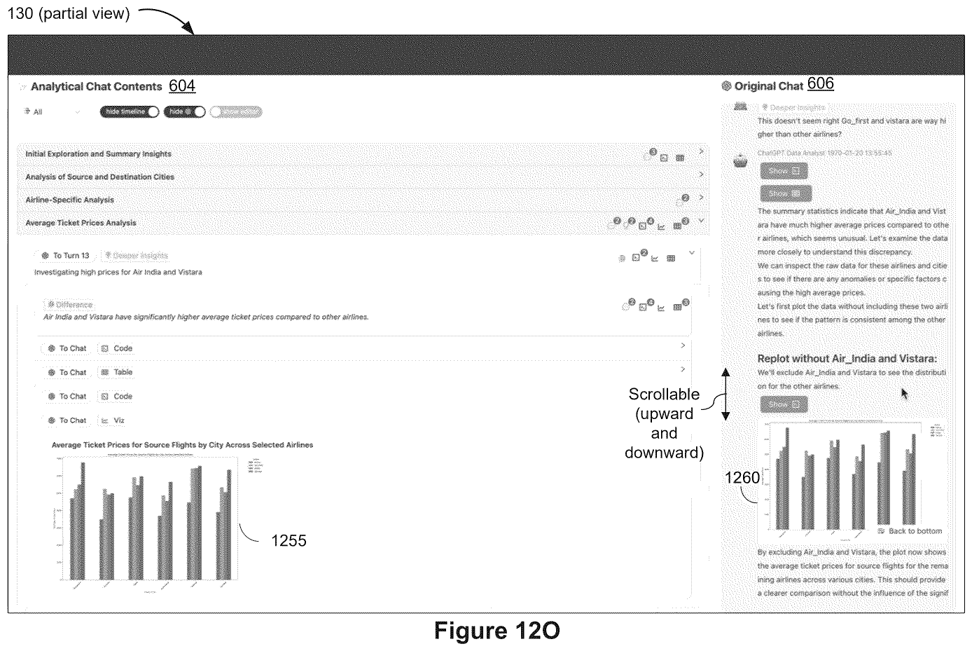

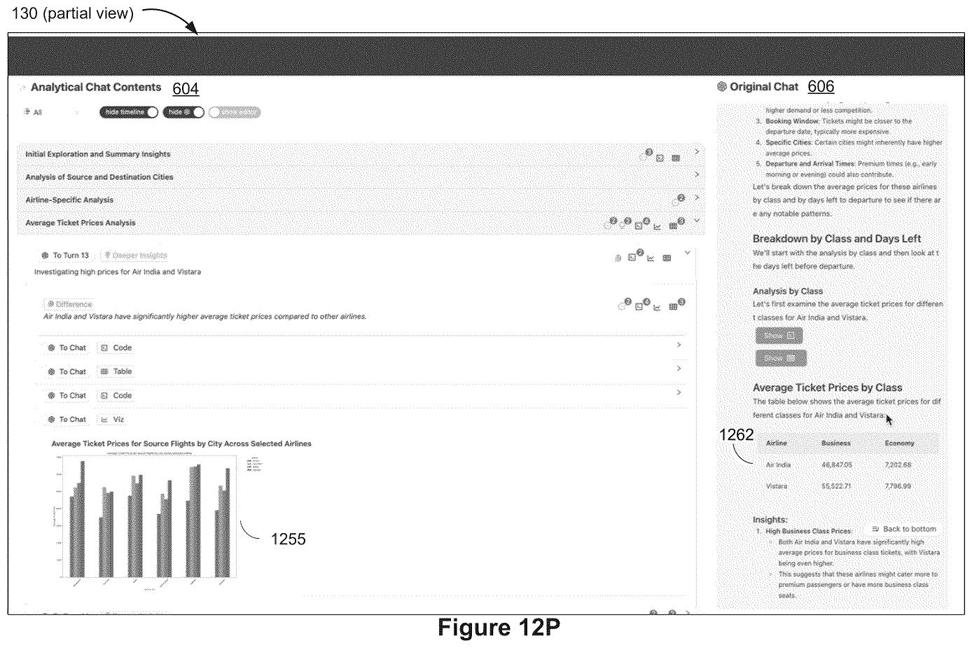

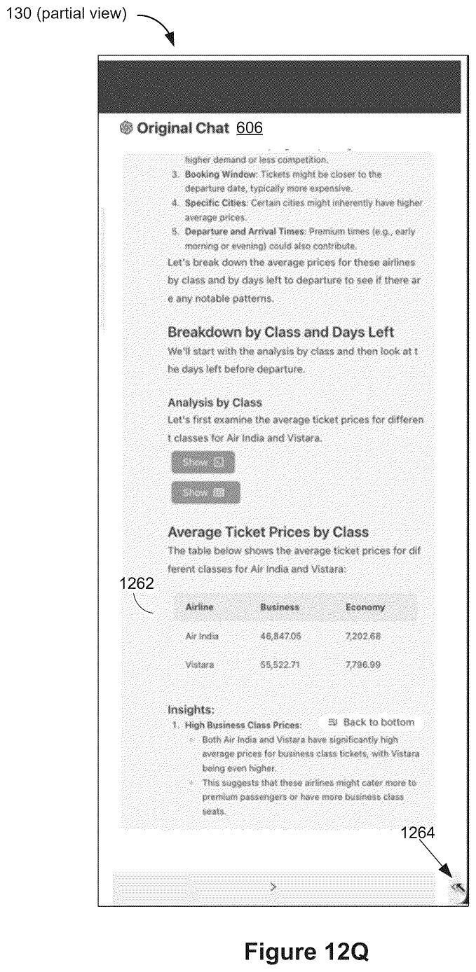

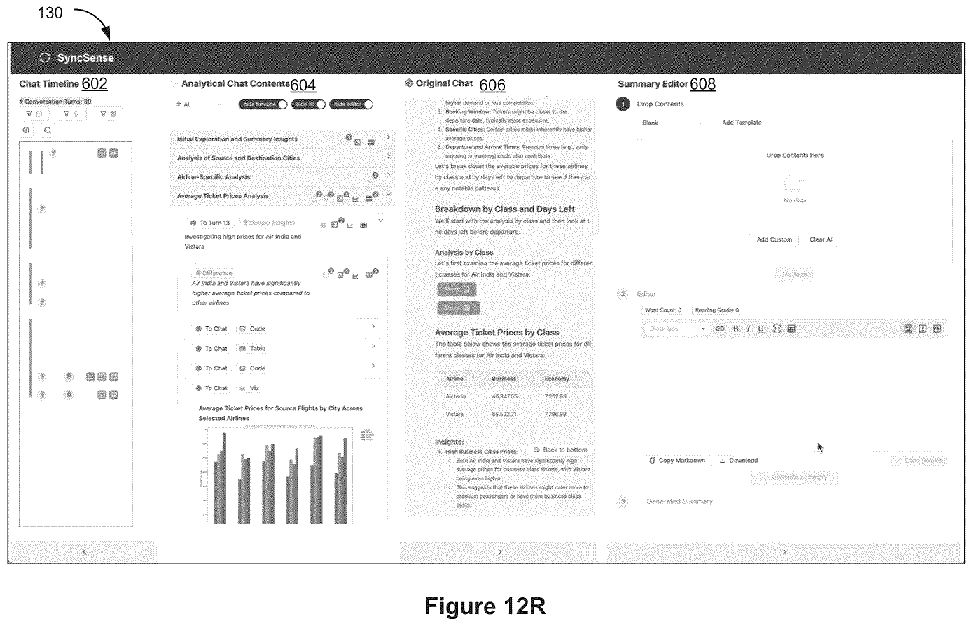

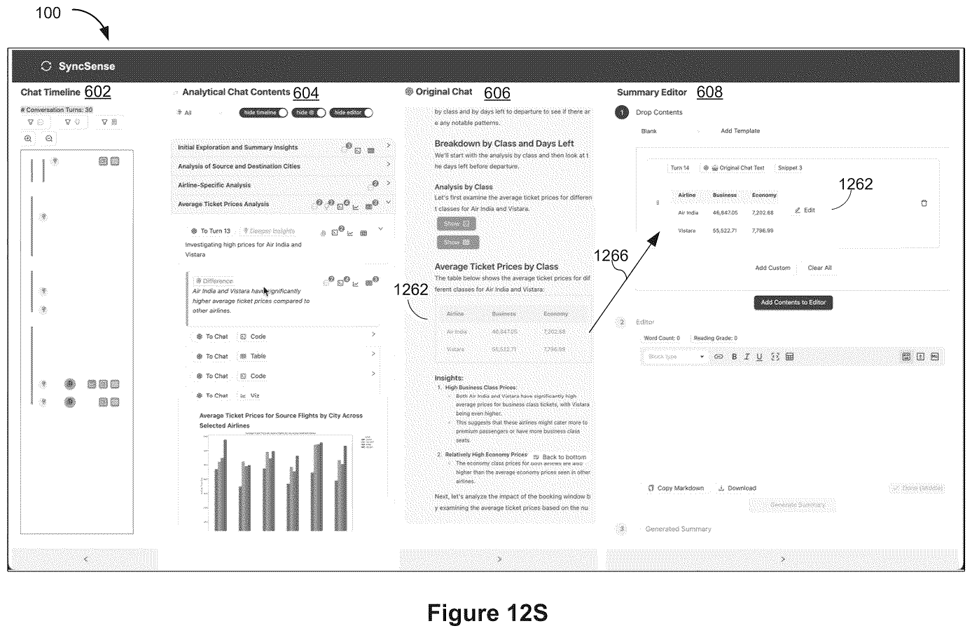

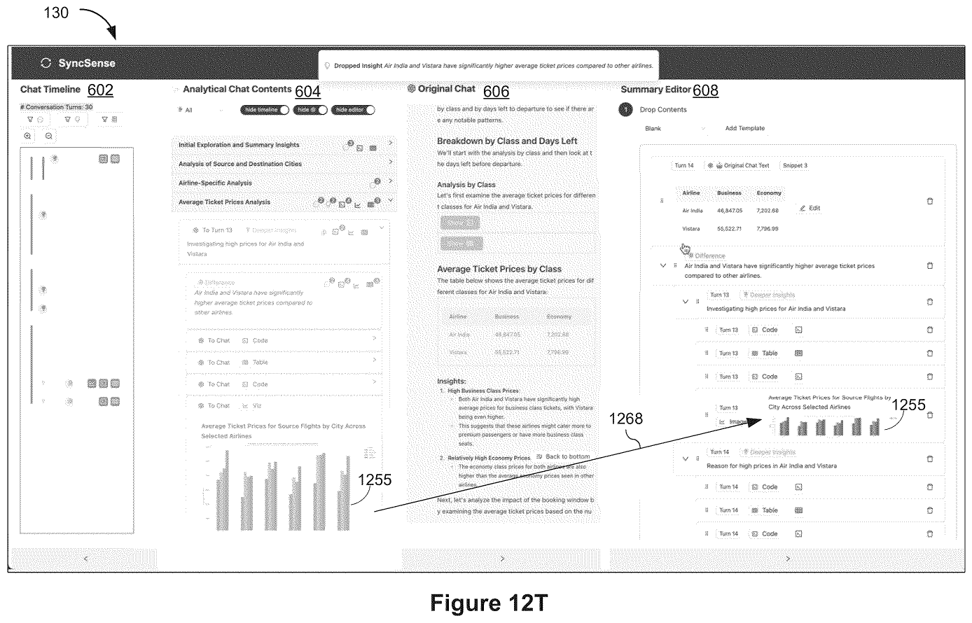

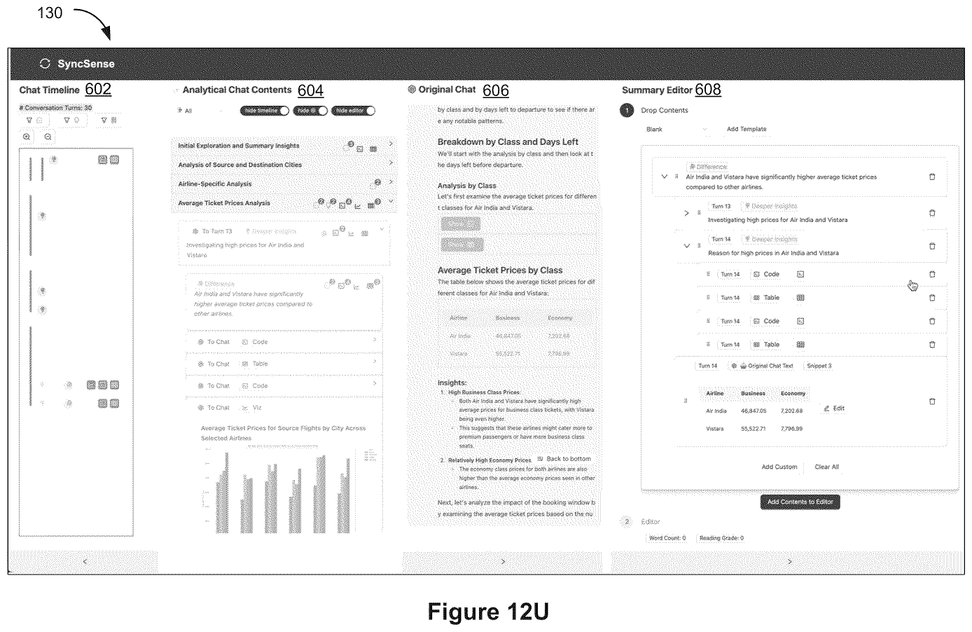

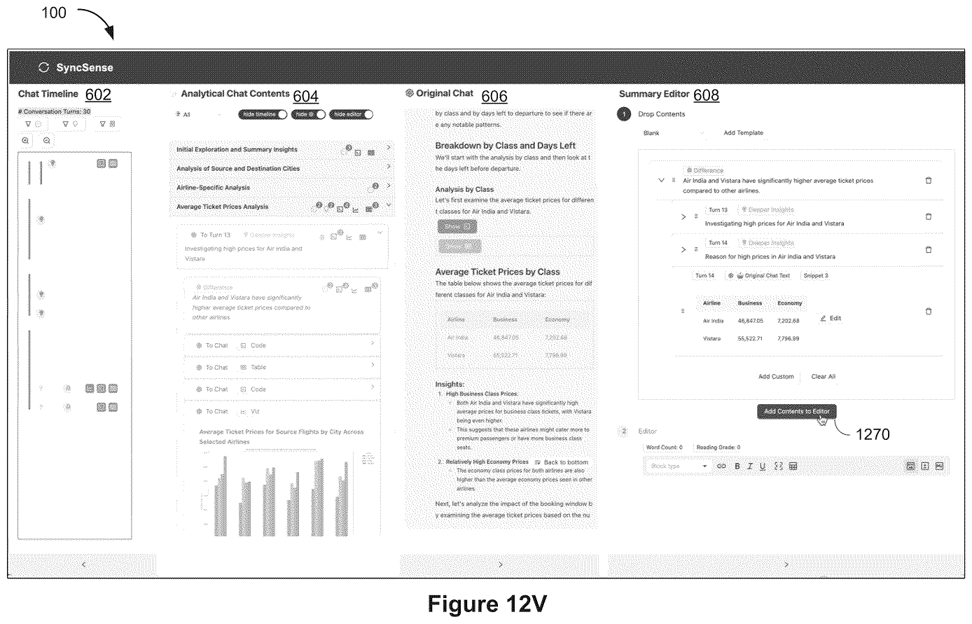

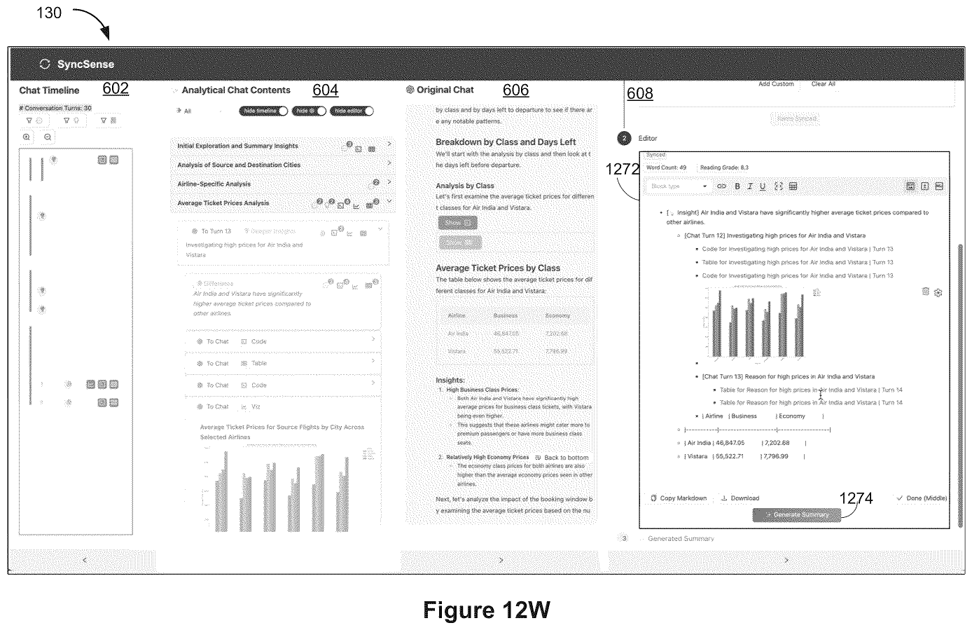

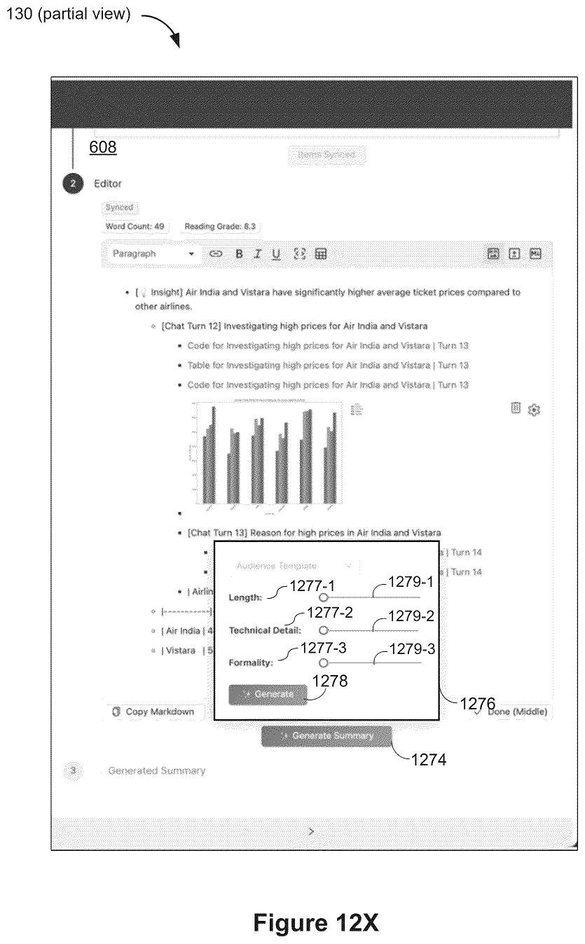

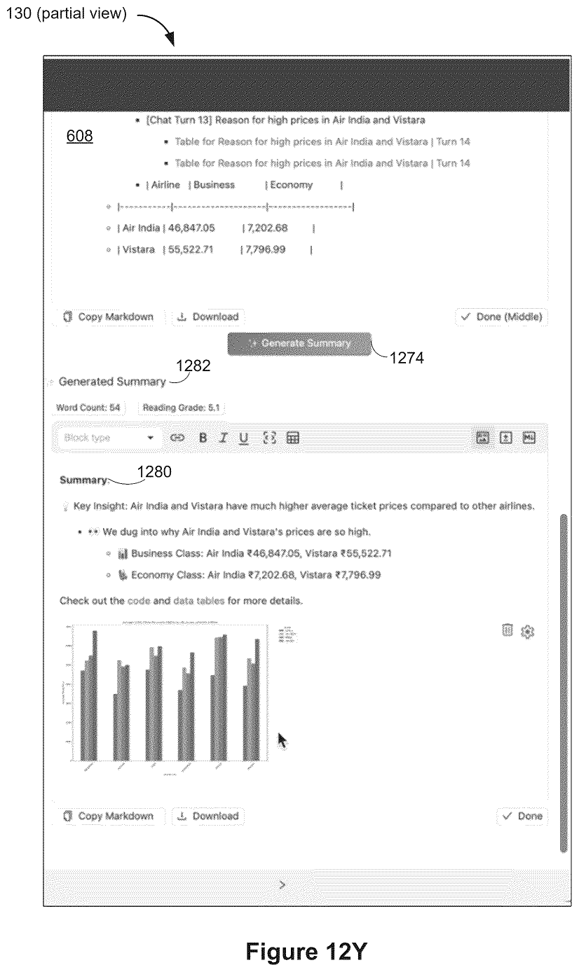

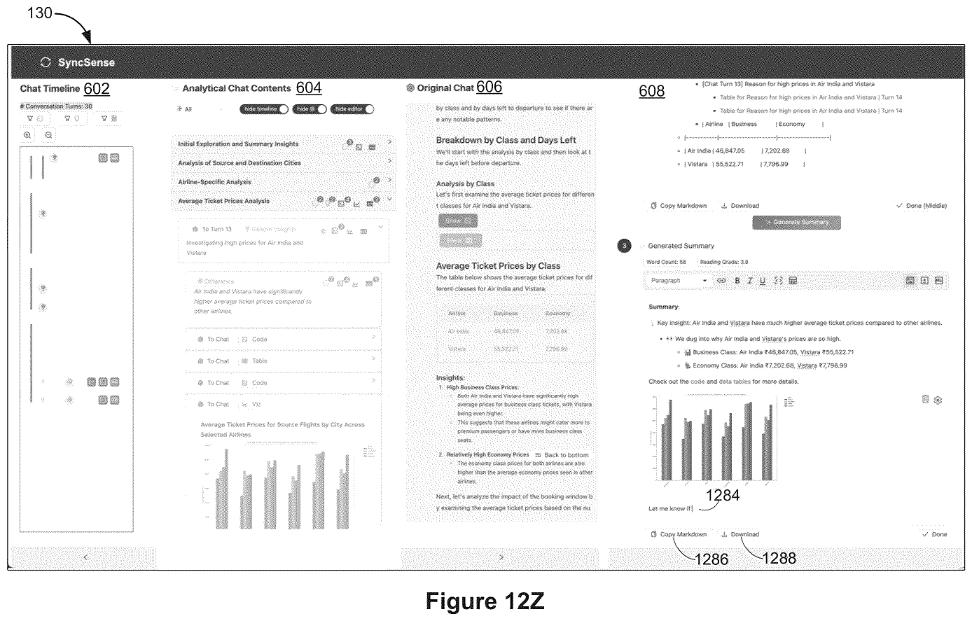

In the content extraction phase 102, SyncSense receives inputs 106, including chat history 108 (e.g., via a URL) of an analytical conversation and a dataset 110. SyncSense executes the code from the chat history 108 and uses data from the dataset 110 to generate artifacts (e.g., generated artifacts 124). In some embodiments, SyncSense uses a sandboxed Python environment 120 with the exact libraries used in OpenAI's code execution environment to execute the code, thus ensuring consistent artifacts are produced. SyncSense applies content extractor 112 to extract, from the chat history, other conversational components 119 such as conversation threads, insights, and speech acts. In some embodiments, content extractor 112 is an AI model. In some embodiments, content extractor 112 is a large language model (LLM). In some embodiments, content extractor 112 uses three LLM modules (three separate LLM API calls) to extract threads 114, extract and categorize insights 116, and categorize speech acts 118, as illustrated in FIG. 1. In some embodiments, SyncSense uses OpenAI's GPT-4o for LLM-based functionalities. In some embodiments, to extract threads for analysis, SyncSense prompts the content extractor 112 (e.g., LLM) to summarize each turn-pair in the conversation. It then iteratively merges sub-threads based on their similarity, as determined by the content extractor 112. Preliminary experiments by the inventors indicated that this iterative merging approach is more stable compared to using a single prompt. In some embodiments, the generated artifacts 124 and the other conversational components 119 are displayed as chat contents 122 on user interface 130, via one or more panels that are described with respect to FIGS. 6A to 6C and 12A to 12Z.

A user can interact (e.g., via user interactions 131) with chat contents 122 that are displayed in the user interface. For example, the user can drag content (e.g., text, images, or artifacts that the user would like included in the summary from one or more panels of the user interface to an authoring panel of the user interface to generate markdown input 132, which is displayed in the user interface 130. In the summary generation phase 104, an LLM summarizer 134 takes the markdown input 132 and user configurations in the post-drop editor as input to adapt and generate (via an API call) a summary (e.g., generated summary 136). In some embodiments, SyncSense uses OpenAI's GPT-4o for summary generation. In some embodiments, SyncSense displays the generated summary 136 in the user interface 130. In some embodiments, SyncSense enables the generated summary 136 to be exported to external application(s) such as a messaging application, an email application, email, a data presentation/communication application, or a reporting software application.

In some embodiments, SyncSense is implemented in the React framework based on Typescript using the Ant Design library for UI components. It uses React Drag and Drop (DnD) for the drop container and MDX Editor for the markdown editor. The backend is implemented in Python using FastAPI, which is designed to extract the chat contents from the Chat URL, execute the code within the chat, and generate summaries.

### Block Diagrams

FIG. 2 is a block diagram of a computing device 200, in accordance with some embodiments. Various examples of the computing device 200 include a desktop computer, a laptop computer, a tablet computer, and other computing devices that have a display and a processor capable of running an application 230 (e.g., SyncSense). In some embodiments, the computing device 200 is a virtual reality (VR) device, an augmented reality (AR) device, or a spatial computing device that blends digital content with the physical world. The computing device 200 typically includes one or more processing units (processors or cores) 202, one or more network or other communication interfaces 204, memory 206, and one or more communication buses 208 for interconnecting these components. In some embodiments, the communication buses 208 include circuitry (sometimes called a chipset) that interconnects and controls communications between system components.

The computing device 200 includes a user interface 210. The user interface 210 typically includes a display device 212. In some embodiments, the computing device 200 includes input devices such as a keyboard, mouse, and/or other input buttons 216. Alternatively or in addition, in some embodiments, the display device 212 includes a touch-sensitive surface 214, in which case the display device 212 is a touch-sensitive display. In some embodiments, the touch-sensitive surface 214 is configured to detect various swipe gestures (e.g., continuous gestures in vertical and/or horizontal directions) and/or other gestures (e.g., single/double tap). In computing devices that have a touch-sensitive display 214, a physical keyboard is optional (e.g., a soft keyboard may be displayed when keyboard entry is needed). The user interface 210 also includes an audio output device 218, such as speakers or an audio output connection connected to speakers, earphones, or headphones.

Furthermore, some computing devices 200 use a microphone 220 and voice recognition to supplement or replace the keyboard. In some embodiments, the computing device 200 includes an audio input device 220 (e.g., a microphone) to capture audio (e.g., speech from a user).

In some embodiments, the memory 206 includes high-speed random-access memory, such as DRAM, SRAM, DDR RAM, or other random-access solid-state memory devices. In some embodiments, the memory 206 includes non-volatile memory, such as one or more magnetic disk storage devices, optical disk storage devices, flash memory devices, or other non-volatile solid-state storage devices. In some embodiments, the memory 206 includes one or more storage devices remotely located from the processors 202. The memory 206, or alternatively the non-volatile memory devices within the memory 206, includes a non-transitory computer-readable storage medium. In some embodiments, the memory 206, or the computer-readable storage medium of the memory 206, stores the following programs, modules, and data structures, or a subset or superset thereof:
an operating system 222, which includes procedures for handling various basic system services and for performing hardware dependent tasks;
a communications module 224, which is used for connecting the computing device 200 to other computers (e.g., server 300) and devices via the one or more communication interfaces 204 (wired or wireless), such as the Internet, other wide area networks, local area networks, metropolitan area networks, and so on;
a web browser 226 (or other application capable of displaying web pages), which enables a user to communicate over a network with remote computers or devices;
an audio input module 228 (e.g., a microphone module), which processes audio captured by the audio input device 220. The captured audio may be sent to a remote server (e.g., a server system 300) and/or processed by an application executing on the computing device 200;
an application 230 (e.g., SyncSense). In some embodiments, the application 230 includes:
   a user interface 130 (e.g., also known as a graphical user interface, or GUI, as illustrated in FIGS. 1, 6A to 6C, and 12A to 12Z);
   a content extraction module 232 (e.g., content extractor 112). In some embodiments, content extraction module 232 is configured to extract conversational components 233 from chat histories of analytical conversations with datasets and datasets. In some embodiments, the conversational components 233 include conversation turns (e.g., turn pairs), speech acts; analysis artifacts (e.g., ode, visualizations, table, or execution output), data insights (e.g., numerical or statistical results derived from data in the dataset and/or chat history), and conversation threads and/or sub-threads;
   a Content Summarizer Module 234; and
   a content rendering module 236 for generating and displaying user interface 130. In some embodiments, the content rendering module 236 renders the plurality of conversational components as interactive affordances on the user interface;
one or more other applications 240. For example, in some embodiments, the one or more other applications 240 can include a messaging application such as Slack®, an email application, a data presentation/communication application such as Microsoft PowerPoint®, Tableau Software®, Microsoft PowerBI®, or a reporting software application;
zero or more datasets or data sources 248 (e.g., dataset 110), which are used by the application 230, the one or more other applications, and/or data processing models 258;
APIs 256 for receiving API calls from one or more applications (e.g., a web browser 226, an application 230, other applications 240) and/or data processing models 258, translating the API calls into appropriate actions, and performing one or more actions; and
data processing models 258. In some embodiments, the data processing models 258 are applied to process datasets 248. In some embodiments, the data processing models 258 include one or more large language models (LLMs) 260, one or more large vision models (LVMs) 262, and one or more AI agents 264. In some embodiments, the data processing models 258 include rule-based systems or statistical models.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set of time intervals or in real time based on resulting output or additional data to further train the AI technology. The AI technology may offer a variety of capabilities including text, audio, image, or content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 206 stores a subset of the modules and data structures identified above. Furthermore, the memory 206 may store additional modules or data structures not described above. In some embodiments, a subset of the programs, modules, and/or data stored in the memory 206 is stored on and/or executed by a server system 300.

Although FIG. 2 shows a computing device 200, FIG. 2 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to the computing device 200 may be stored or executed on a server system 300.

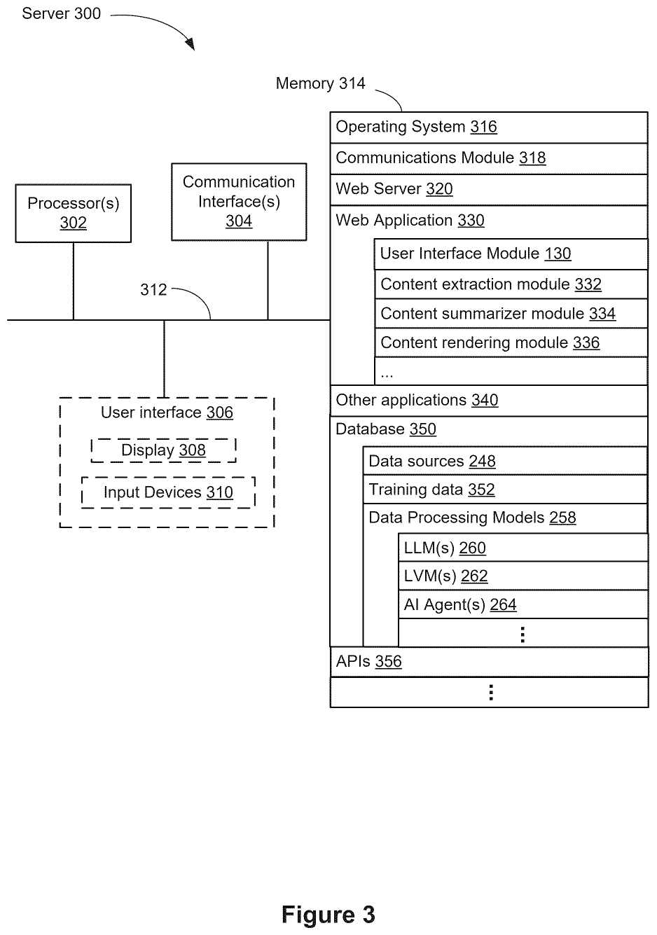

FIG. 3 is a block diagram of a server system 300, in accordance with some embodiments. The server system 300 typically includes one or more processing units/cores (CPUs) 302, one or more network interfaces 304, memory 314, and one or more communication buses 312 for interconnecting these components. In some embodiments, the server system 300 includes a user interface 306, which includes a display 308 and one or more input devices 310, such as a keyboard and a mouse. In some embodiments, the communication buses 312 include circuitry (sometimes called a chipset) that interconnects and controls communications between system components.

In some embodiments, the memory 314 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. In some embodiments, the memory 314 includes one or more storage devices remotely located from the CPUs 302. The memory 314, or alternatively the non-volatile memory devices within the memory 314, comprises a non-transitory computer readable storage medium.

In some embodiments, the memory 314 or the computer readable storage medium of the memory 314 stores the following programs, modules, and data structures, or a subset thereof:
an operating system 316, which includes procedures for handling various basic system services and for performing hardware dependent tasks;
a network communications module 318, which is used for connecting the server 300 to other computers via the one or more communication network interfaces 304 (wired or wireless) and one or more communication networks, such as the Internet, other wide area networks, local area networks, metropolitan area networks, and so on;
a web server 320 (such as an HTTP server), which receives web requests from users and responds by providing responsive web pages or other resources;
a web application 330 (e.g., SyncSense web application), which may be downloaded and executed by a web browser 226 on a user's computing device 200. In general, a web application 330 has the same functionality as application 230, but provides the flexibility of access from any device at any location with network connectivity, and does not require installation and maintenance. In some embodiments, the web application 330 includes various software modules to perform certain tasks, such as:
   a user interface module 130, which provides the user interface for all aspects of the web application 330;
   a content extraction module 332, which has the same functionalities as content extraction module 232;
   a content summarizer module 334, which has the same functionalities as content summarizer module 234; and
   a content rendering module 336, which has the same functionalities as content rendering module 236;
one or more other applications 340. For example, in some embodiments, the one or more other applications 340 can include a chart application, an email application, or a data processing application In some embodiments, the other applications 340 can include a messaging application such as Slack®, a data presentation/communication application such as Microsoft PowerPoint®, Tableau Software®, Microsoft PowerBI®, or a reporting software application;
database 350. In some embodiments, the database 350 includes:
   zero or more datasets or data sources 248, which are used by web application 330, other applications 340, and/or data processing models 258;
   training data 352 for training the data processing models 258; and
   one or more data processing models 258. In some embodiments, the data processing models 258 include one or more large language models (LLMs) 260, one or more large vision models (LVMs) 262, and one or more AI agents 264; and
APIs 356 for receiving API calls from one or more applications (e.g., a web server 320, a web application 330, and other applications 340) and the one or more data processing models 258, translating the API calls into appropriate actions, and performing one or more actions.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set of time intervals or in real time based on resulting output or additional data to further train the AI technology. The AI technology may offer a variety of capabilities including text, audio, image, or content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 314 stores a subset of the modules and data structures identified above. Furthermore, the memory 314 may store additional modules or data structures not described above.

Although FIG. 3 shows a server system 300, FIG. 3 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to a server system 300 may be stored or executed on a computing device 200. In some embodiments, the functionality and/or data may be allocated between a computing device 200 and one or more servers 300. Furthermore, one of skill in the art recognizes that FIG. 3 need not represent a single physical device. In some embodiments, the server functionality is allocated across multiple physical devices in a server system. As used herein, references to a “server” include various groups, collections, or arrays of servers that provide the described functionality, and the physical servers need not be physically colocated (e.g., the individual physical devices could be spread throughout the United States or throughout the world).

### Components of an Analytical Conversation

In accordance with some embodiments, to provide structure to an analytical conversation to both better support navigation and provide a common language for constructing a summary from conversation contents, SyncSense breaks the raw conversation down into meaningful components relevant to the navigation needs.

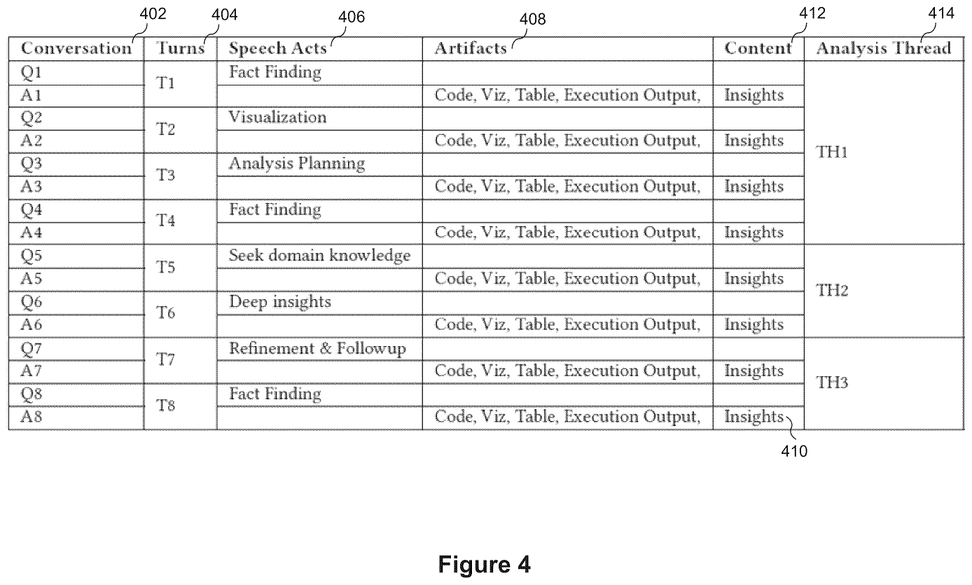

FIG. 4 illustrates the components of an analytical conversation (e.g., conversational components 233), in accordance with some embodiments. The components are also referred to herein as conversational components or analytical conversation components. In some embodiments, the components include conversation turns (e.g., turn pairs), speech acts, analysis artifacts (e.g., ode, visualizations, table, or execution output), data insights (e.g., numerical or statistical results derived from data in the dataset and/or chat history), and conversation threads and/or sub-threads It should be noted that the components as illustrated in FIG. 4 intended to be useful and comprehensive, and is not exhaustive.

In some embodiments, the conversational components include turns or conversation turns 404. At the most basic level, an analytical conversation 402 is a sequence of turns between the user and the assistant. Specifically, the turn involves a user prompt turn (e.g., “Can you compare prices by airlines?”) and an assistant response turn (e.g., a question-and-answer pair, such as (Q1, A1), (Q2, A2), and (Q3, A3) in FIG. 4. Therefore, turn can help users quickly identify the prompts in a conversation. In addition to this utility, some embodiments focus on turns as a core base component of a conversation as they can be traced to a relatively small snippet of the entire conversation and are tied to the other core components of a conversation.

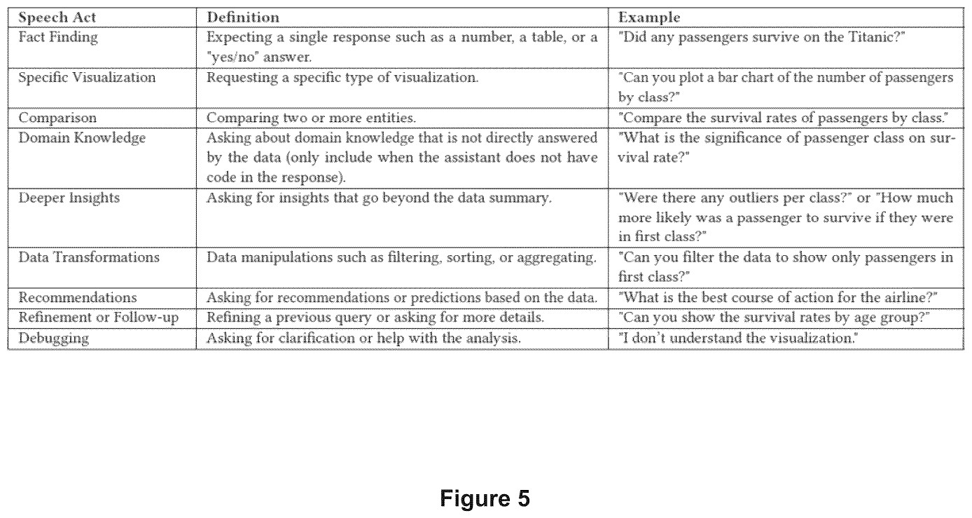

In some embodiments, the conversational components include speech acts 406. A user prompt can be categorized into speech acts, which define the role each prompt plays in the conversation (e.g., comparison). In some embodiments, speech acts can help aid in the provenance of the analytical context and how it changes over time. A speech act can have a respective category (e.g., type). Exemplary categories of speech acts include fact finding, specific visualization, comparison, domain knowledge, deeper insights, data transformations, recommendations, refinement or follow-up, a comparison, and debugging. FIG. 5 illustrates definitions and examples of different speech act categories, in accordance with some embodiments.

In some embodiments, the conversational components include analysis artifacts 408. In each assistant response, there can be zero or more artifacts. In some embodiments, analysis artifacts 408 can include code, data visualizations, data tables, and execution outputs associated with the analysis that are relevant to the analytical conversation. Visualizations and data tables serve as essential components in the presentation of analyses while code can help with the provenance and verification of how visualizations and tables were generated.

In some embodiments, the conversational components include data insights 410. In some embodiments, data insights are the content 412 of the analytical conversation. In some embodiments, data insights 410 are critical outcomes of any data analysis. Data insights can be challenging to uncover because they often become buried within back-and-forth exchanges, lengthy text, and analysis artifacts. Furthermore, it can be difficult to organize data insights effectively due to the volume and complexity of the information. In some embodiments, data insights are classified using the taxonomy proposed by Wang et al. in “DataShot: Automatic Generation of Fact Sheets from Tabular Data,” IEEE Transactions on Visualization and Computer Graphics 26 (2020), 895-905, which is incorporated by reference herein in its entirety. In some embodiments, in analytical discussions, insights can be linked to one or more responses from the assistant.

In some embodiments, the conversational components include threads and sub-threads (e.g., analysis threads 414). Data analysis is an iterative and exploratory process, and may involve deep dives into or revisions of a previously explored analysis thread.

Although current commercial analytical chatbots tend to be single-threaded conversations, they still naturally contain threads that are useful for navigation and organization of analysis contents. In addition, nested threads (where threads can be nested within larger threads) naturally serve as different abstraction levels to the contents of a conversation and provide necessary structure as the analyses grow in length and complexity. Some embodiments consider a thread that can contain sub-threads or turn-pairs. In some embodiments, a leaf thread contains two or more (potentially non-consecutive) turn-pairs.

In some embodiments, the conversational components can include other components such as data attributes (e.g., data fields and data values of data fields), or the stages of an analysis.

FIGS. 6A, 6B-1, 6B-2, and 6C illustrate various views of the SyncSense user interface (e.g., user interface 130), in accordance with some embodiments.

FIG. 6A shows that the user interface 130 includes a chat timeline panel 602 (panel A in FIG. 6A) having a chat timeline 610 for surfacing key components of the conversation (e.g., conversational components 233), thereby offering a quick overview of the entire conversation. In some embodiments, each component type (e.g., conversational components 233) is represented by a respective distinct icon in the timeline, with the icons arranged to follow the natural structure in the conversation as illustrated in FIG. 6A and 6B-1. Therefore, turns appear in the order they occurred in the original discussion, and each row represents each turn. Likewise, the speech act, insights, and artifacts associated with the turn are also present in the row. To ensure a consistent visual language throughout SyncSense's other panels, each component type (e.g., threads, speech acts/turns, insights, and artifacts) is represented in its own color. Because speech acts represent the user query turn in a turn-pair, some embodiments overload the color for turns with that of speech acts. When applicable, additional icons are used to help identify the exact type of the chat component (e.g., the speech act category or the insight type). In addition, nested threads are shown in blue as vertical bars to indicate which turns in the conversation are associated with that thread. The threads are nested vertically (parent threads to the left of child threads) to show the natural abstraction of conversation threads. Advantageously, the multi-level abstraction feature enables users to engage with conversations at varying levels of detail and enables summaries to be customized depending on the audience.

The chat timeline panel 602 can include an iconized timeline (A1) and filtering options (A2). FIG. 6B shows that above the chat timeline 610, filter options (e.g., facets) are included. The filter options include a filter option 612 for filtering speech acts (e.g., filter the turns in the conversation), a filter option 614 for filtering insight types, and a filter option 616 for filtering the artifact types (e.g.., the code, data tables, and visualizations). The filter options, when selected, not only update the icons residing in the chat timeline 610 but also those in the analytical chat contents panel 604. In some embodiments as disclosed, SyncSense enables the categorization of user queries based on intent categories (e.g., speech act categories) such as comparison, fact-finding, or recommendations and facilitates the process of quickly filtering and navigating conversations. This speech act categorization is particularly useful for managing complex conversations and stands out against competitor tools that lack this level of intent-based filtering and organization.

To support detail on demand, hovering over threads, speech acts, or insights reveals additional information about the hovered component. Clicking on an icon will display the corresponding component in both the analytical chat contents panel 604 and the original chat panel 606, allowing users to navigate directly to the relevant content for more details and trace back to the original conversation. Similarly, clicking on artifact icons opens a popover showing artifacts of that type for the selected turn. In some embodiments, clicking is used instead of hovering to display the popover, as popovers take up more screen space and could obstruct the interface if shown accidentally. The popover includes buttons for quick navigation to the related content in both the analytical chat contents panel 604 and the original chat panel 606.

FIGS. 6A, 6B-1, and 6B-2 show that the user interface 130 includes an analytical chat contents panel 604 (e.g., panel B in FIG. 6A) that offers multiple view options (B1 in FIG. 6A) and icons indicating nested content for each component (B2 in FIG. 6A), in accordance with some embodiments.

The analytical chat contents panel 604 enables more in-depth exploration of the chat contents compared to the chat timeline 610, while still maintaining an abstracted view compared to the raw conversation. In some embodiments, to accommodate different information-seeking needs, the analytical chat contents panel 604 includes three distinct views, each structured to emphasize the most relevant information for the task. Within these views, related components are nested under parent components that can be revealed by clicking the “>” button 618. In some embodiments, the views include “All View,” “Turn View,” and “Insights View. ” “All View” displays threads and turns at the top level, with artifacts and insights nested within them. “Turn View” lists all turns in sequence, along with their associated artifacts and insights. “Insights View” prioritizes insights, nesting the relevant turns and artifacts beneath each one. The different views (e.g., “All View,” “Turn View,” and “Insights View”) enables users to engage with conversations at varying levels of detail, according to specific needs and contexts, and differentiates from other existing solutions that typically provide static, one-size-fits-all summaries.

In some embodiments, for each insight, turn, or thread, relevant tags are displayed with consistent iconography and coloring that matches the chat timeline 610, offering users a quick visual overview. In some embodiments, to assist users in orienting themselves within the conversation, hovering over the contents in the Analytical Chat Contents panel triggers an increase in the size of the corresponding icon in the chat timeline 610. In some embodiments, to help users get a sense of the contents nested within a content block, icons representing the content e.g., turns, artifacts, or insights) with the counts of that content are presented.

In some embodiments, the user interface 130 includes original chat panel 606 (Panel C in FIG. 6A, and FIG. 6B-2). In some embodiments, to help users maintain the provenance of the extracted content relative to the original chat and to provide additional context and verification, SyncSense provides the original raw conversation in the original chat panel 606. Displaying original raw conversation in the original chat panel 606 also helps to differentiate SyncSense's LLM-extracted content and non-LLM generated content. Unlike current ChatGPT shared chats, which do not even include visualization contents in the original chat panel 606 can include all artifacts and can be navigated from the other abstracted panels.

In some embodiments, the user interface 130 includes a summary editor panel 608 (panel D in FIG. 6A), which is an authoring panel for creating custom summaries.

Users can drag elements from the analytical chat contents panel 604 or the original chat panel 606 into the summary editor panel 608, and restructure the contents from there.

While the previous panels (e.g., chat timeline panel 602, analytical chat contents panel 604, original chat panel 606) facilitate navigation and information retrieval, the summary editor panel 608 enables users to quickly craft summaries based on conversation components. FIG. 6C illustrates details of the summary editor panel 608, in accordance with some embodiments. The summary editor panel 608 includes the drag-and-drop container, illustrated in panels A and B of FIG. 6C, a post-drop editor, illustrated in panel C of FIG. 6C, and a post-LLM editor, illustrated in panel D of FIG. 6C. Overall, SyncSense aims to provide an intuitive experience for composing summary content through drag-and-drop interactions and LLM-assisted manipulations, while also allowing precise control over the content via markdown edits.

Drag and Drop Container. Prior work on supporting writing with speech has found that breaking down the entire text into semantically meaningful segments and supporting actions on these segments helps authors review and create spoken content more effectively. Some embodiments of the present disclosure we provide a drag-and-drop container that allows users to quickly assemble summary content. Users can drag any chat component (e.g., thread, turn, insight, or artifact) from the Analytical Chat Contents panel into this container. Items dragged will include all nested content, with the hierarchy preserved. Each content item appears as a block, with nested elements indented. In addition, to support copying of text directly from the original conversation, users can also drag any text or artifact in the original chat panel 602. Each block in the container is fully draggable, enabling easy reorganization of order and nesting structure. Once users are satisfied with the arrangement, they can click the “Add Contents to Editor” button. This action serializes the chat contents into markdown, with each item in the container becoming a bullet point in the editor and nested components as indented bullets. For some chat components, additional metadata is added to indicate the type of content (e.g., an insight will be prefixed with “[Insight]”).

Post Drop Editor. Users can edit the plain markdown in the editor, which supports features like code, images, and tables. The post drop editor provides a structured and readable view of the chat contents in markdown format. If users require further assistance in refining their summary, they can click the “Generate Summary” button. This opens sliders that allow users to adjust the content, and an LLM generates a refined summary, which is displayed in a separate post-LLM editor. The content in the markdown editor serves as the input to the LLM, ensuring transparency in how the final summary is produced.

Post-LLM Editor. The post-LLM editor contains the output of the LLM-generated summary. Users can make additional adjustments if necessary. To allow portability to different mediums (e.g., documents and messaging platforms), users can copy or download the markdown contents when they are finished.

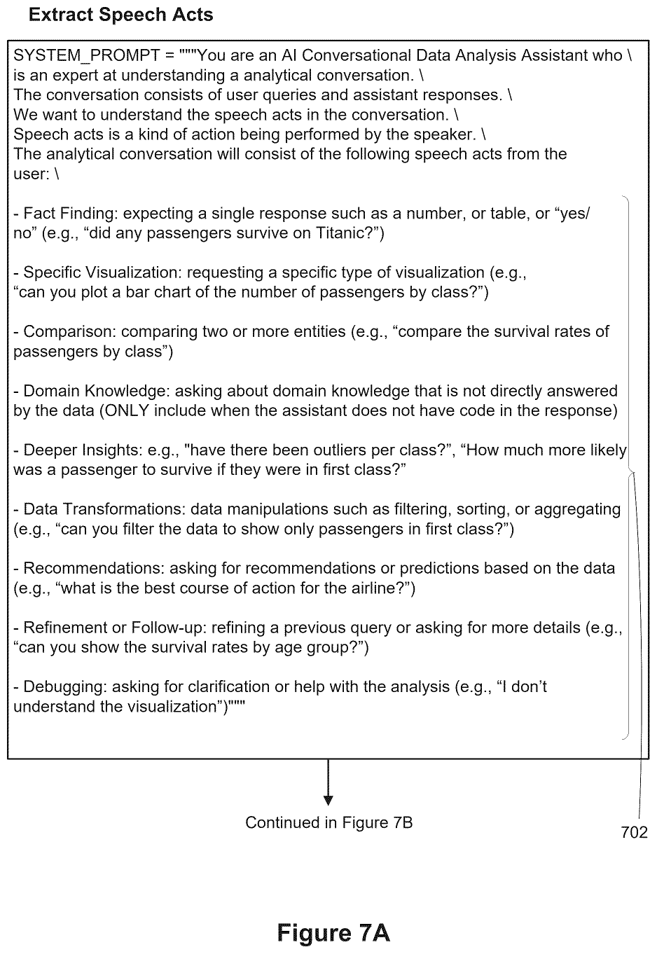

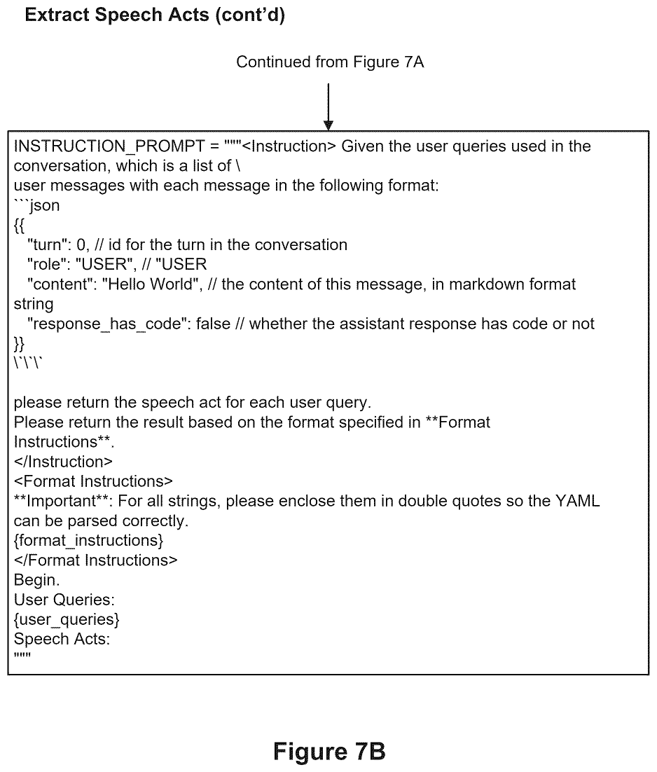

FIGS. 7A and 7B is an example prompt that is input by a computer system executing SyncSense into data processing models 258 (e.g., LLM(s) 260) to extract speech acts, in accordance with some embodiments.

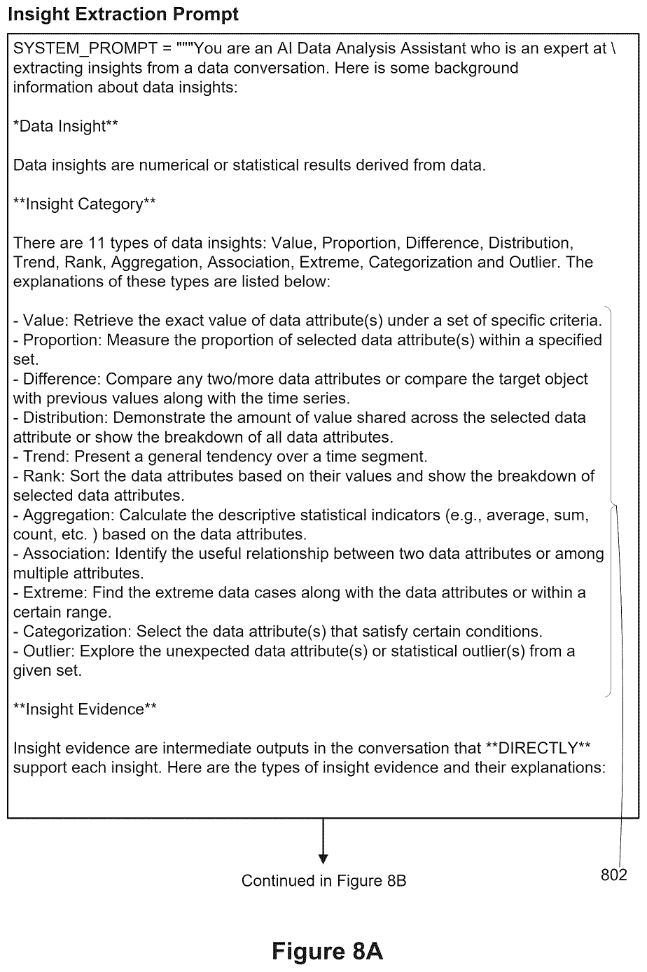

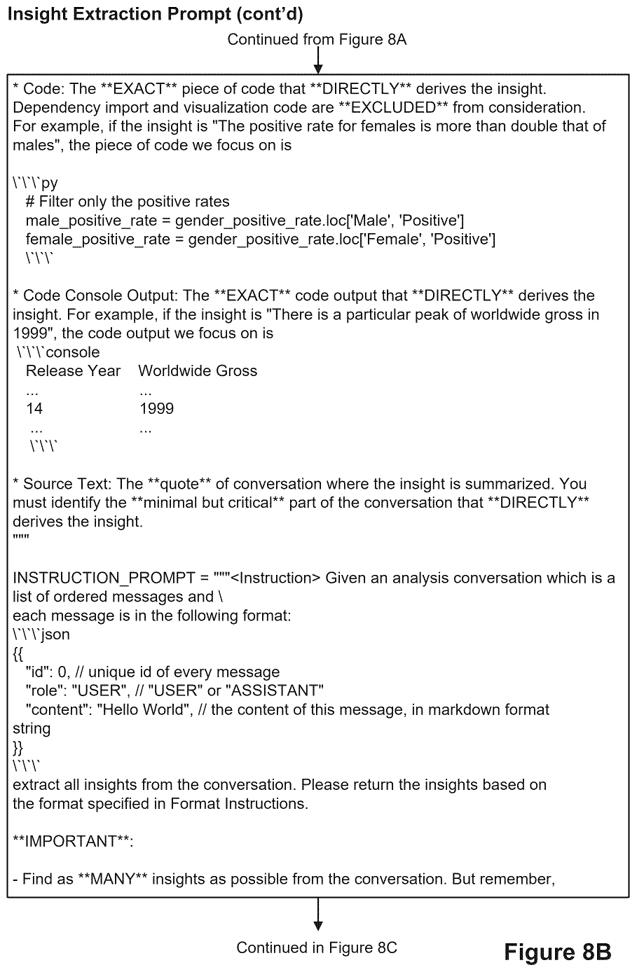

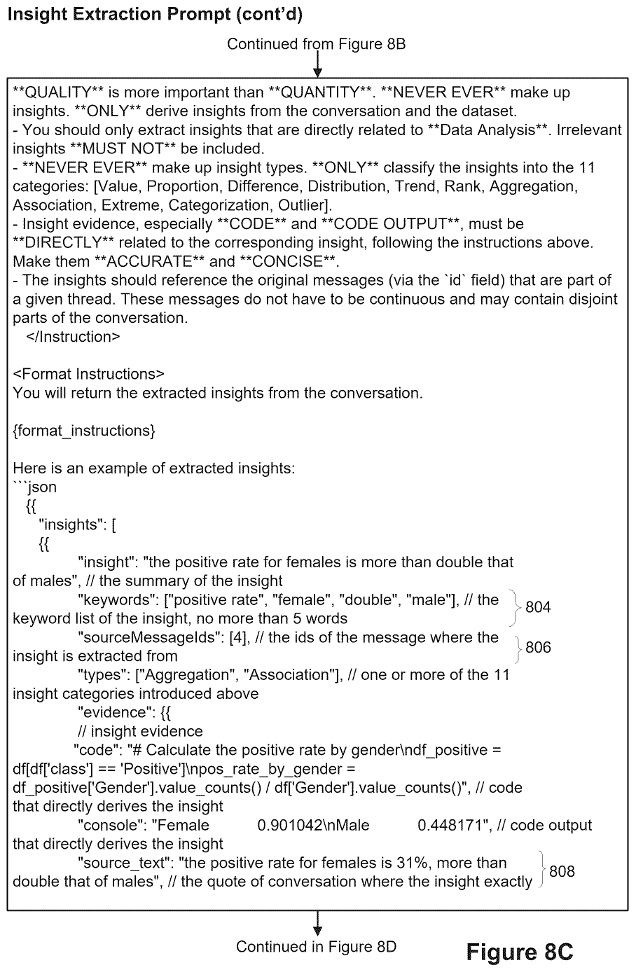

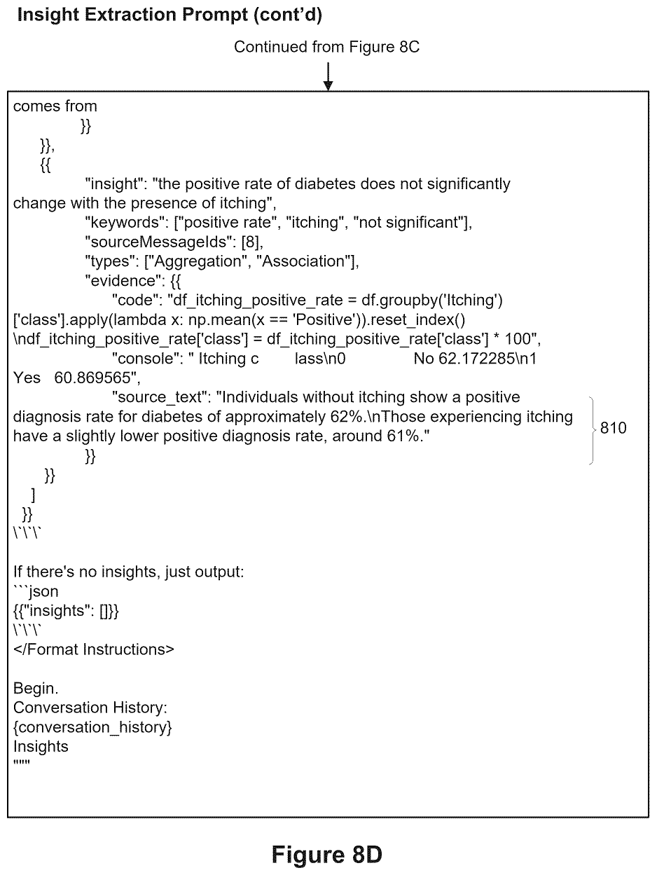

FIGS. 8A to 8D is an example prompt that is input by a computer system executing SyncSense into data processing models 258 (e.g., LLM(s) 260) to extract data insights from analytical conversations, in accordance with some embodiments.

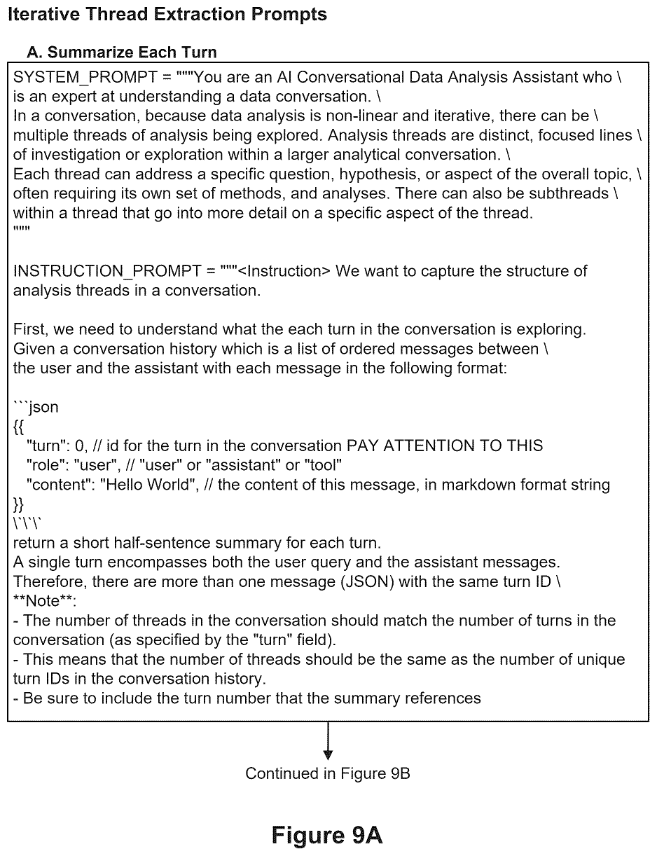

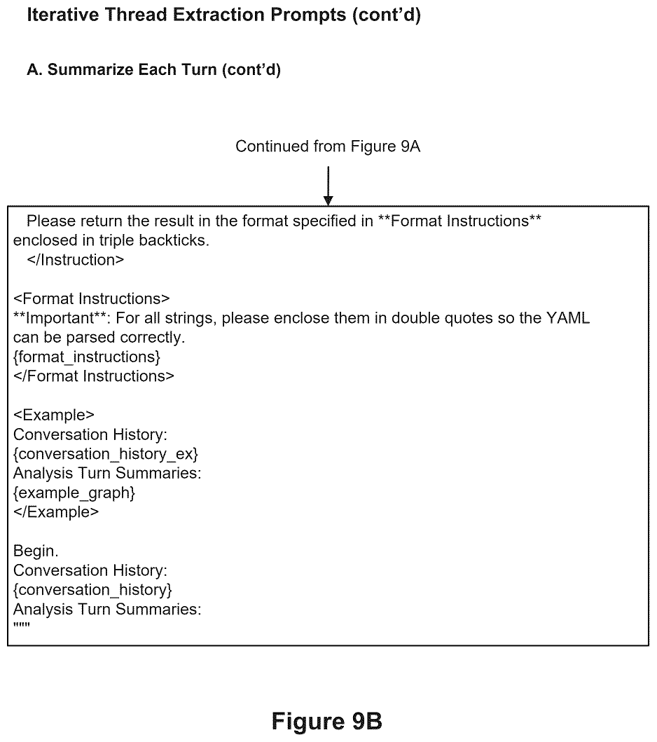

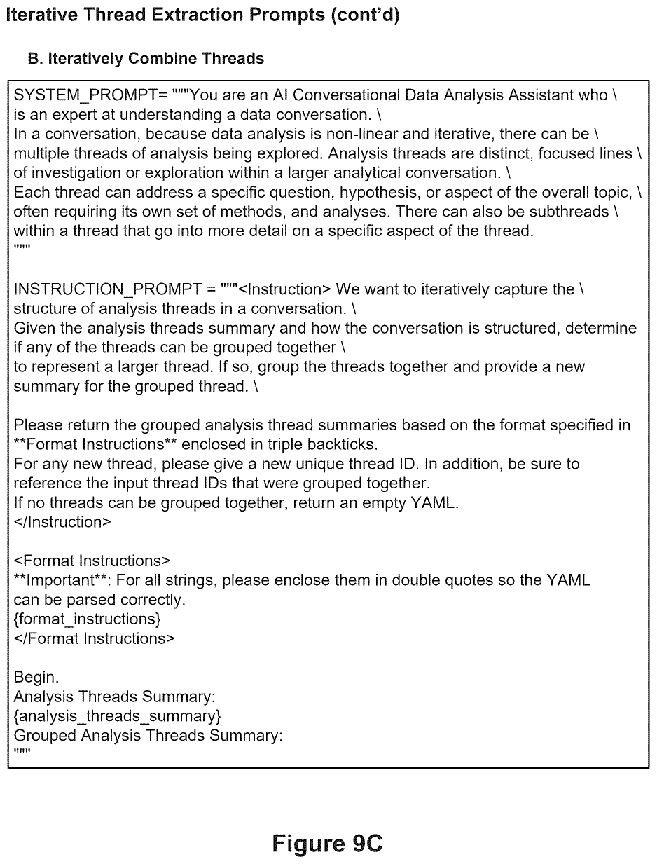

FIGS. 9A to 9C are example prompts that are input by a computer system executing SyncSense into data processing models 258 (e.g., LLM(s) 260) to iteratively extract conversation threads, in accordance with some embodiments.

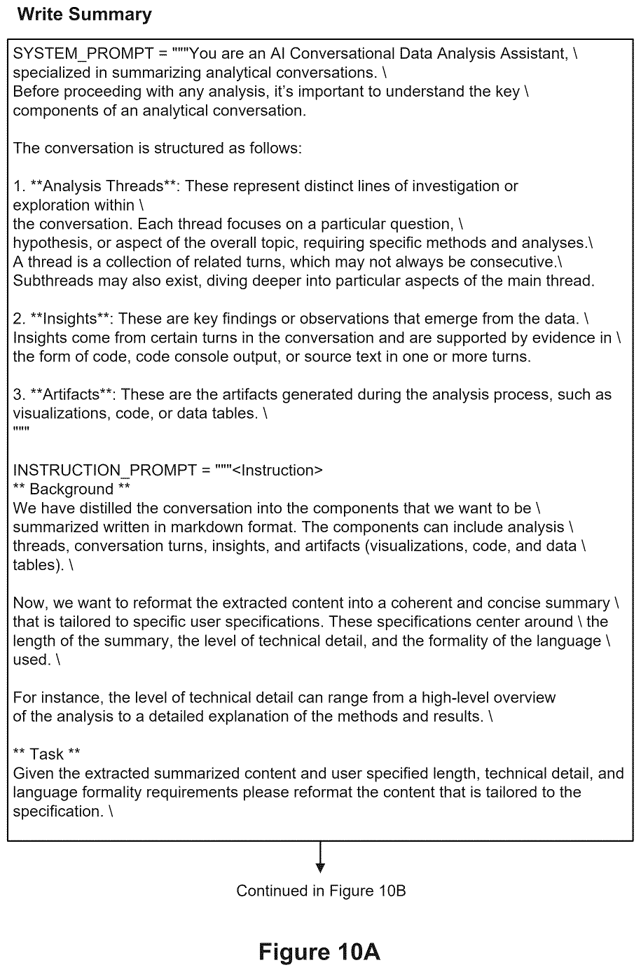

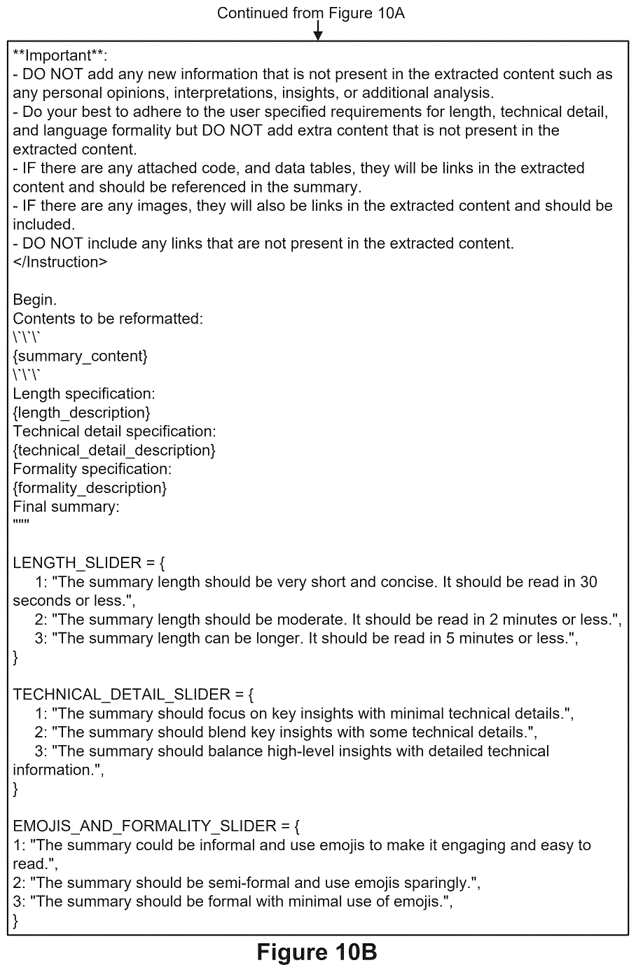

FIGS. 10A and 10B illustrate an example prompt that is input by a computer system executing SyncSense into data processing models 258 (e.g., LLM(s) 260) to summarize analytical conversations, in accordance with some embodiments.

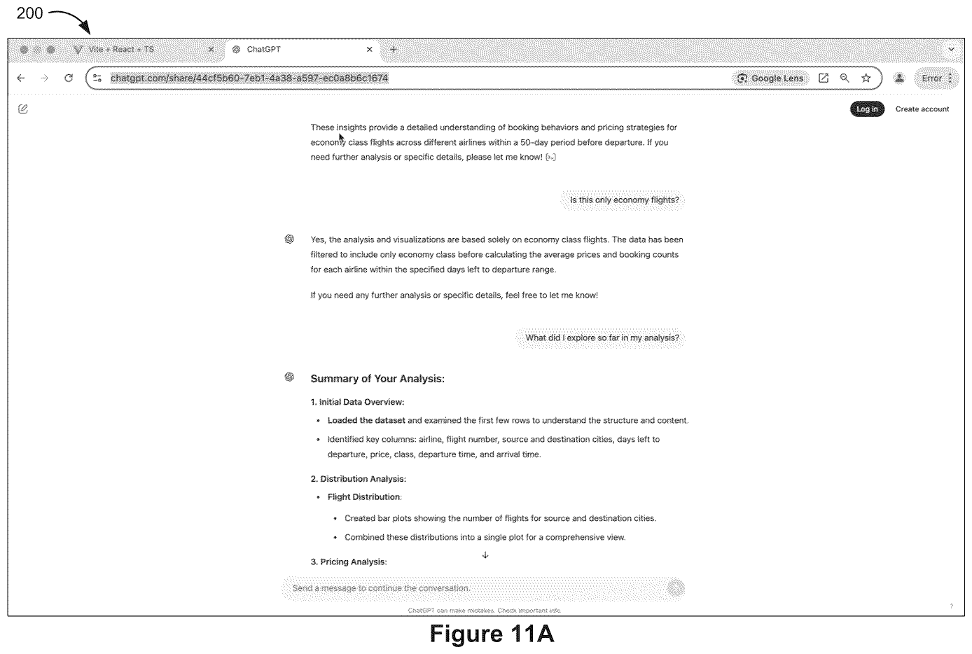

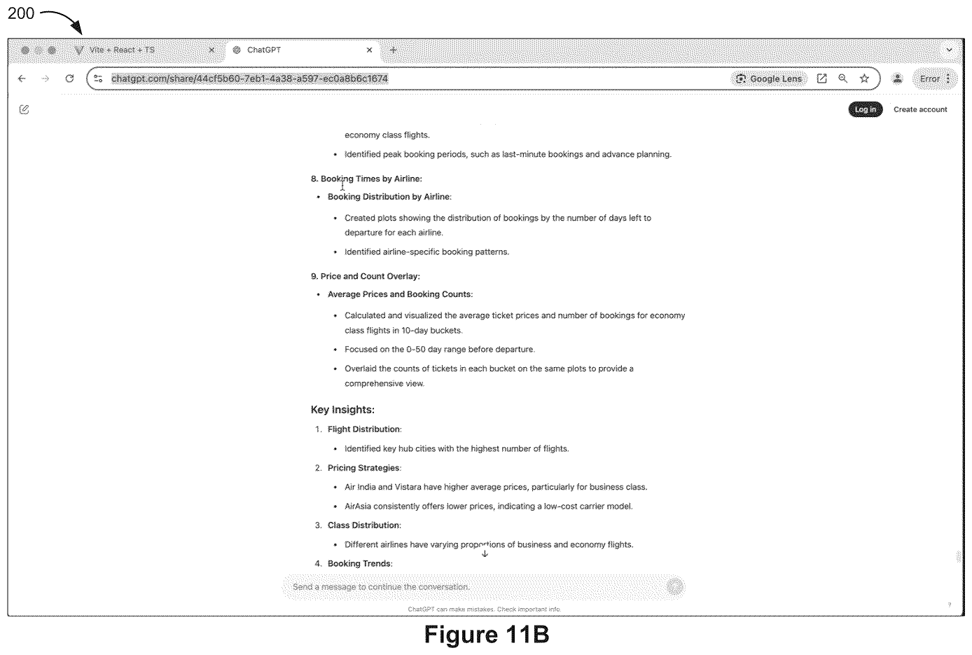

FIGS. 11A to 11B are screenshots illustrating user interactions with an AI conversational platform (e.g., ChatGPT®), in accordance with some embodiments. 12A to 12Z are screenshots illustrating user interactions with SyncSense, in accordance with some embodiments. In the example of FIGS. 11 and 12, the user is a data analyst at an airline company who uses the AI conversational platform to analyze transit flight ticket prices.

FIGS. 11A and 11B are screenshots illustrating a user's interactions (e.g., conversation) with an AI conversational platform such as ChatGPT®. In many instances, these interactions are what would be shown if the user were to share it with others right now. As shown in FIGS. 11A and 11B, the conversation is long, static and hard to make sense of, especially when shared with others who did not do the analysis.

In accordance with some embodiments of the present disclosure, the user can apply SyncSense to summarize the analytical conversation in a message (e.g., a Slack message, an email, or a text message) to send to a product manager on her team. In this example, because the product manager is non-technical, the data analyst would like to tailor the summary to the intended audience by providing a high level overview and the main insights.

FIG. 12A illustrates an initial view 1202 of the SyncSense user interface 130, in accordance with some embodiments. Here, the user begins by uploading the raw dataset 1204 for flights and prices. The user also inputs a URL 1206 corresponding to the user interactions with the AI conversational platform (e.g., as shown in FIGS. 12A and 12B). The user then selects the “Get Chat Data” affordance button 1208, which causes SyncSense to load the conversation through executing the code to obtain visualization data tables and extract the chat contents.

FIG. 12B illustrates the main interface of SyncSense with the chat timeline panel 602 and analytical chat contents panel 604, also discussed with reference to FIGS. 6A to 6C. The chat timeline panel 602 displays a scrollable chat timeline 1210 (e.g., scrollable in an upward or downward direction 1212) of the user's prior interactions with the AI conversational platform. In some embodiments, the user can gather a high level overview of the prior interactions with the AI conversational platform by exploring the chat timeline. For example, the user can scroll or hover over the contents (e.g., icons) into the chat timeline 1210, something that was difficult for her to do in the original conversation shared link.

FIGS. 12C to 12G show partial views of the user interface 130 with the chat timeline panel 602. By scrolling and hovering over the chat timeline 1210, the user can uncover details about analysis threads 1214 (e.g., analysis thread 1214-1, analysis thread 1214-2, and analysis thread 1214-3). In FIG. 12C, user selection of analysis thread 1214-1 reveals details such as the number of turns 1216 (e.g., conversation turns) and the number of conversation segments 1218 corresponding to that analysis thread. A conversation segment 1218 refers to a cohesive unit of the analytical conversation that encapsulates a particular analysis or topic. Conversation segments 1218 are defined by identifying related conversation turns, insights, and artifacts that collectively address a specific analytical inquiry or task. The user can also discover details about turn pairs (e.g., by selecting or hovering over icon 1220), insights (e.g., by selecting or hovering over icon 1222), and artifacts. For example, the user can select or hover over icon 1224 to cause the user interface 130 to display a visualization 1226. The user can select or hover over icon 1228 such as to cause the user interface 130 to display code snippets 1230. FIGS. 12C, 12D, and 12E further illustrate that the speech acts are represented as yellow-colored icons, the insight types are represented as green-colored icons, and the analysis artifacts are represented as gray-colored icons in the user interface 130. Each category of speech act (e.g., fact finding, specific visualization, comparison, domain knowledge, deeper insights, data transformations, recommendations, refinement or follow-up, and debugging) is represented by an icon with a distinct appearance. Each category of insight type (e.g., value, proportion, difference, distribution, trend, rank, aggregation, association, extreme, categorization, and outlier) is represented by an icon with a distinct appearance. Each type of analysis artifact (e.g., code, visualizations, table, or execution output) is represented by an icon with a distinct appearance, in accordance with some embodiments.

In some instances, the user may observe that not every conversation turn has an insight. In some instances, the user would like to dive only when an insight was requested (e.g., a speech act of Deep Insights). FIGS. 12H and 12I show that the user selects a filter option 612 (e.g., an icon) that pulls up a speech act filter menu 1234 and sets the speech act filter to only deep insights (e.g., by selecting option 1236 in FIG. 12I). There are also other filters she can do with respect to insights and artifacts (e.g., by selecting filter option 614 (e.g., icon) to select or deselect insights options or by selecting filter option 616 to select or deselect artifact types).

FIG. 12J illustrates an updated view of the user interface 130 in response to user selection of the deep insights option. The chat timeline panel 602 displays a filtered timeline 1242 showing just the deep insights. Notably, when the user selects sets the speech act filter to only deep insights, this filter option is synchronized across multiple panels, such as the analytical chat contents panel 604 and the original chat panel 606. This type of dynamic, synchronized navigation is missing from most competitor platforms, which usually offer static conversation logs that limit user control over content exploration.

Now that the user has a clearer understanding of the conversation, the user is able to focus on the analytical chat contents panel 604. Here the analytical chat contents panel 604 displays user-selectable headings 1244 (e.g., headings 1244-1 to 1244-5). In some embodiments, each of the headings 1244 corresponds to a conversation thread group. The headings 1244 correspond to threads or groups of analysis threads. Each heading 1244 captures a distinct segment of the analytical conversation that is logically related to a specific analytical task or inquiry. In some embodiments, SyncSense determines these headings dynamically by analyzing the conversation turns and identifying patterns, themes, or clusters of related speech acts and insights. In FIG. 12J, the user sees that analysis on average ticket price analysis (i.e., heading 1244-4) features two insights (based on the presence of icon 1246), along with a table (based on the presence of icon 1248) and visualizations (based on the presence of icon 1250). The user decides to explore this further and selects affordance 1252 (e.g., “>”).

FIG. 12K illustrates that, in response to the selection of the affordance 1252, the heading 1244-4 expands and the user interface 130 displays details for two insights 1254-1 and 1254-2, corresponding to two conversation turns (e.g., conversation turns “Turn 13” and “Turn 14”). The user notices that these two turns focus on investigating prices for Air India and Vistara. Zoe opens up the first insight 1254-1, which shows a chart 1255 (e.g., an insight) indicating that Air India and Vistara have significantly higher average ticket prices compared to other airlines. This is illustrated in FIG. 12L The user would like to include this insight and wants to make sure the generated visualizations and data tables support this. In some embodiments, the user can toggle the “show” icon 1256 in FIG. 12M to open up the original chat panel 606. FIG. 12N shows that the user interface 130 concurrently displays the chat timeline panel 602, analytical chat contents panel 604, and the original chat panel 606.

The user clicks on the “To turn 13” button 1258. In response to the user selection, the computing device automatically scrolls (e.g., navigates) the contents of the original chat in the original chat panel 606 to display the relevant part of the conversation corresponding to Turn 13, as illustrated in FIG. 12O. The original chat panel 606 shows a visualization 1260 that is identical to the chart 1255 and therefore the user is able to verify the accuracy of the chart 1255 (i.e., the chart 1255 is present in the original chat content).

This brings up another feature of SyncSense, which is the emphasis on provenance preservation. Provenance preservation enables users to trace any summary element back to its original conversation context. This ensures transparency and accountability, particularly for users who need to verify insights or understand how specific conclusions were reached. In contrast, many automated summarization tools in the market lose this traceability, presenting summaries that are detached from their original context.

In some embodiments, the user can explore the contents of the conversation in the original chat panel 606 by scrolling through the contents (e.g., in the upward or downward direction). In FIG. 12P, the user notices a table 1262 that shows that Air India and Vistara have business class tickets that are significantly more expensive than economy class tickets. The user would like to include the table 1262 along with the original insight. In some embodiments, to accomplish this, the user selects icon 1264 located at bottom right corner of the original chart panel 606, as illustrated in FIG. 12Q. This opens up the summary editor panel 608 (e.g., authoring panel), as illustrated in FIG. 12R.

In FIG. 12S, the user drags the table 1262 from the original chat panel into the drop container (e.g., via drag and drop operation 1266). In FIG. 12T, the user drags and drops insights (e.g., chart 1255) from the analytical chat contents panel 604 into the drop container (e.g., via drag and drop operation 1268). In some embodiments, the user reorganizes the content by rearranging and nesting it through simple drag and drop interactions. FIG. 12U illustrates the arrangement of the contents in the summary editor panel 608 after the drag-and-drop interactions, in accordance with some embodiments.

Further, as illustrated in FIGS. 12S, 12T, and 12U, items that are dragged over are now grayed out, indicating visually what items were included in the summary.

At this point, the user considers the dropped contents to be the most important aspect to share with the product manager. The user clicks the “Add Contents to Editor” button 1270 as illustrated in FIG. 12V, which serializes the content into mark down 1272, as illustrated in FIG. 12W. In some embodiments, the user would like to adapt this to be more approachable for Slack. The user uses the LLM assistance feature by selecting or hovering over the “Generate Summary” affordance 1274. In response to the user interaction with the affordance 1274, the user interface 130 displays a menu 1276 that includes options 1277 for a user to customize the length (e.g., via option 1277-1), technical details (e.g., via option 1277-2), and formality (e.g., via option 1277-3) of the summary. This is illustrated in FIG. 12X. The user can specify the length (e.g., shorter or longer), technical details (e.g., less technical details or more technical details), and formality (e.g., less formal to more formal) by sliding the respective slider bars 1279 (e.g., slider bars 1279-1 to 1279-3). Based on the user specification, the LLM assistance takes the user's current contents as input and adapts it based on the user's needs. In this example, the user keeps the current slider settings, which keeps the length, technical detail and formality to the shortest. The user then clicks the Generate button 1278, which causes SyncSense to generate a short summary 1280 with the relevant visualization and displays it in the “Generated Summary” portion 1282 in FIG. 12Y. FIG. 12Z shows that the user has the option to type in a quick comment 1284 for the recipient of the summary, before copying the marked down summary (e.g., by selecting the “copy markdown” icon 1286) or by selecting the “download” icon 1288 to download the summary, and sending the summary to the recipient on an external application (e.g., application 138 or other applications 240) such as Slack.

In summary, SyncSense's structuring of the conversation, consistent visual language tied to these components, and synchronization across panels enables a user to easily recall key parts of her analysis, dig deeper for additional context and verification, and efficiently build and tailor her summary for her teammates.

As disclosed, a differentiator between SyncSense and existing solutions is its combination of AI-assisted and manual summary creation tools. As illustrated in the example of FIGS. 12A to 12Z, users can manually drag-and-drop conversation components to build summaries or opt for LLM-assisted tools that generate customizable summaries based on specific requirements, such as level of technical detail or formality. The AI-assisted method leverages LLM prompts to generate refined summaries based on the user's selected content. Users can adjust sliders (e.g., slider bars 1279) to control the level of technical detail, length, and formality of the generated summary, which is then further refined in a markdown editor. Many existing solutions either rely entirely on manual summarization, which can be time-consuming, or fully automated summaries, which often lack the flexibility to meet diverse user needs.

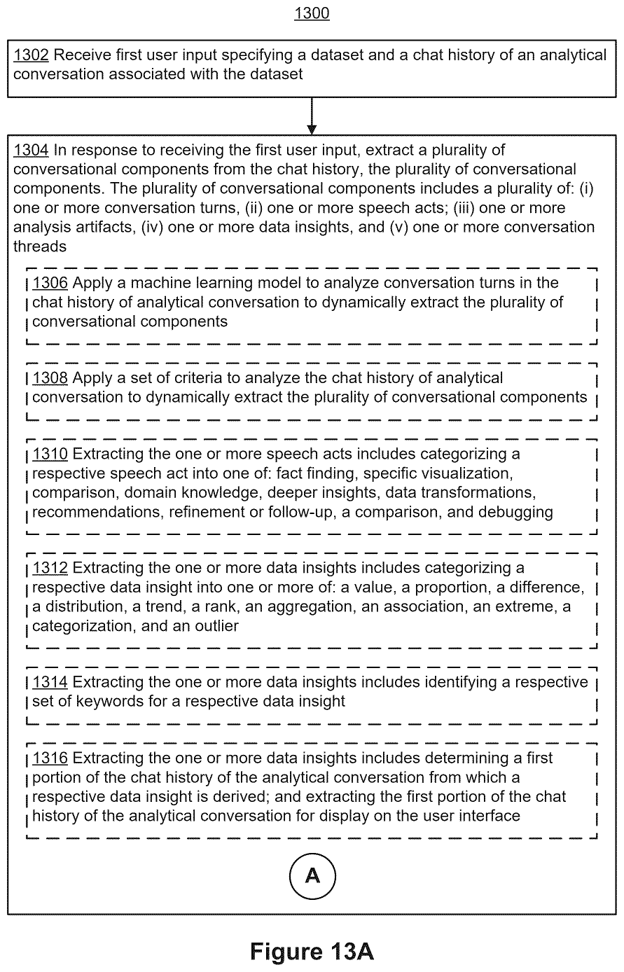

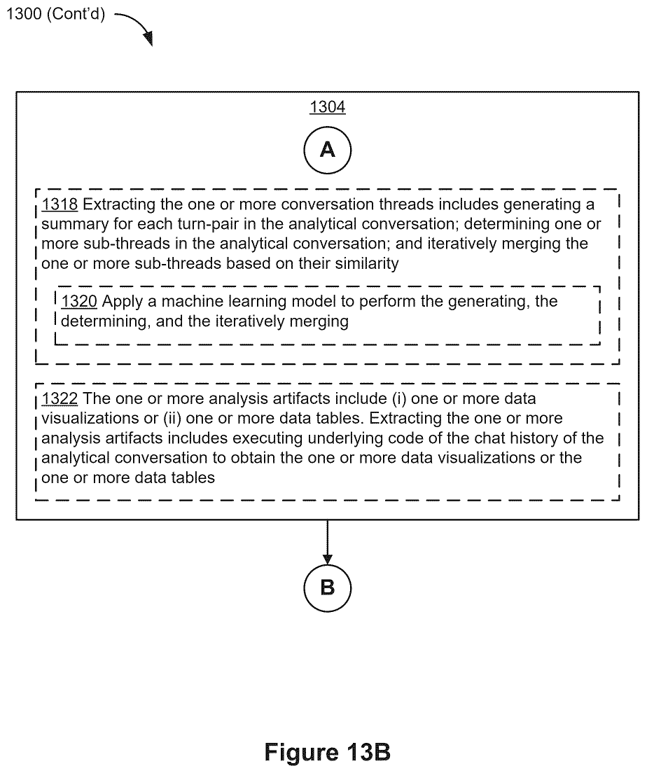

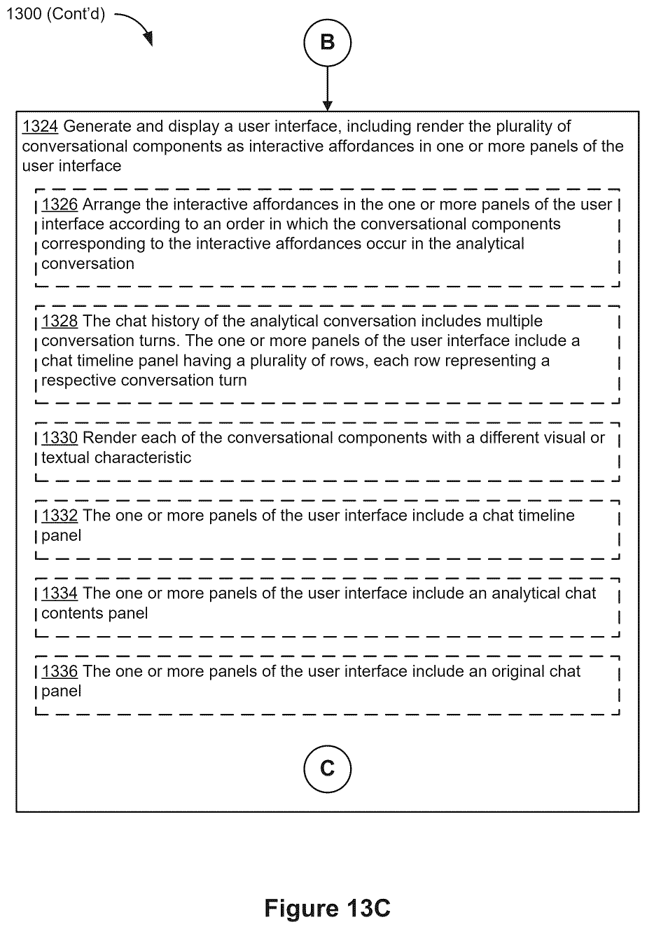

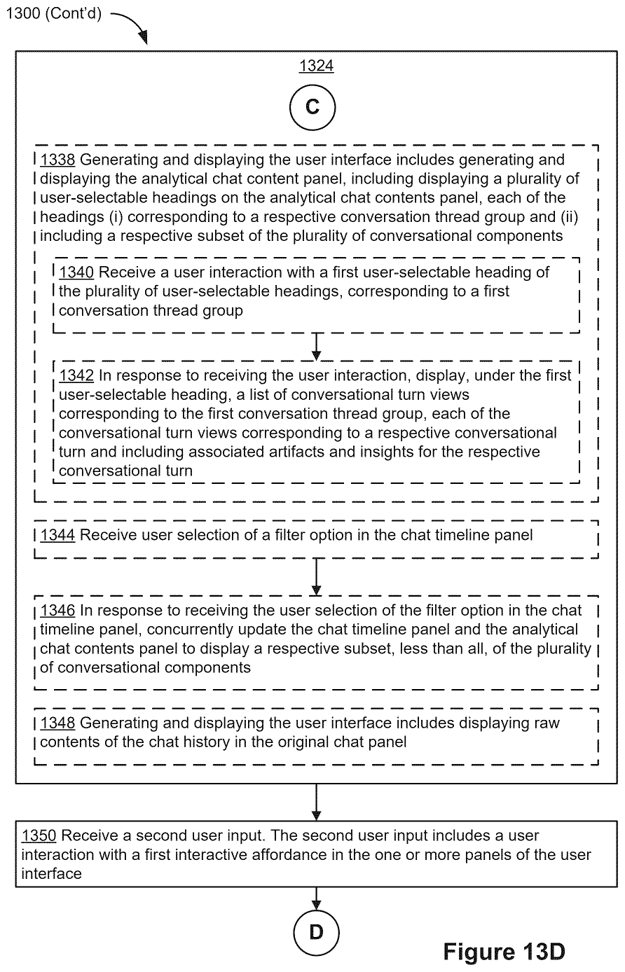

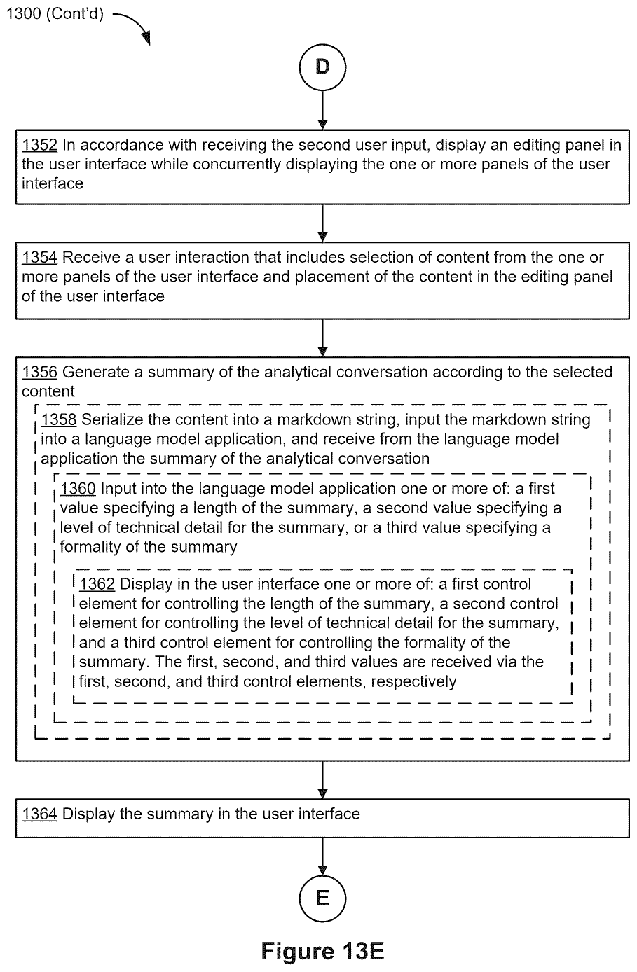

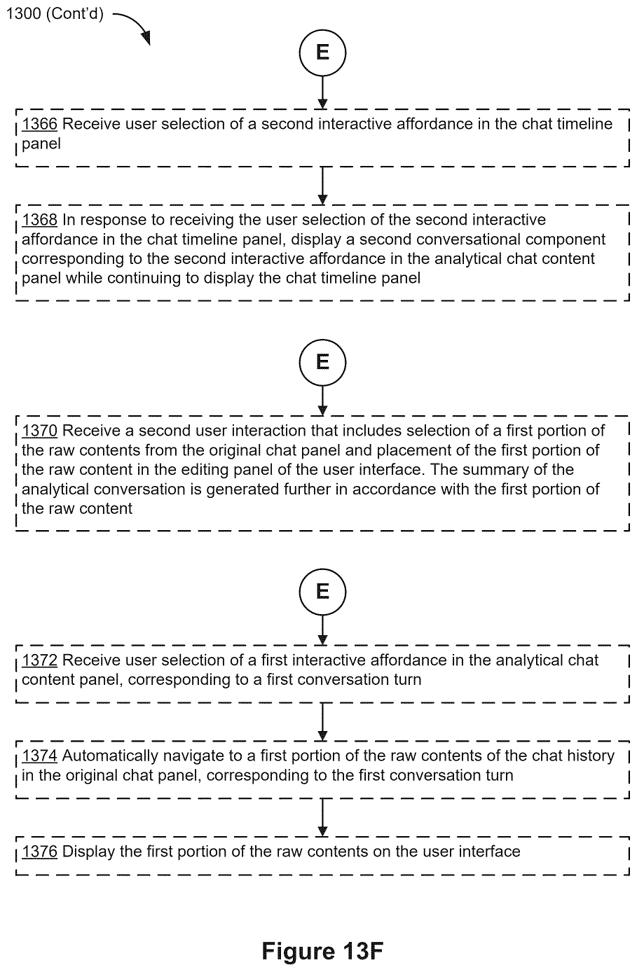

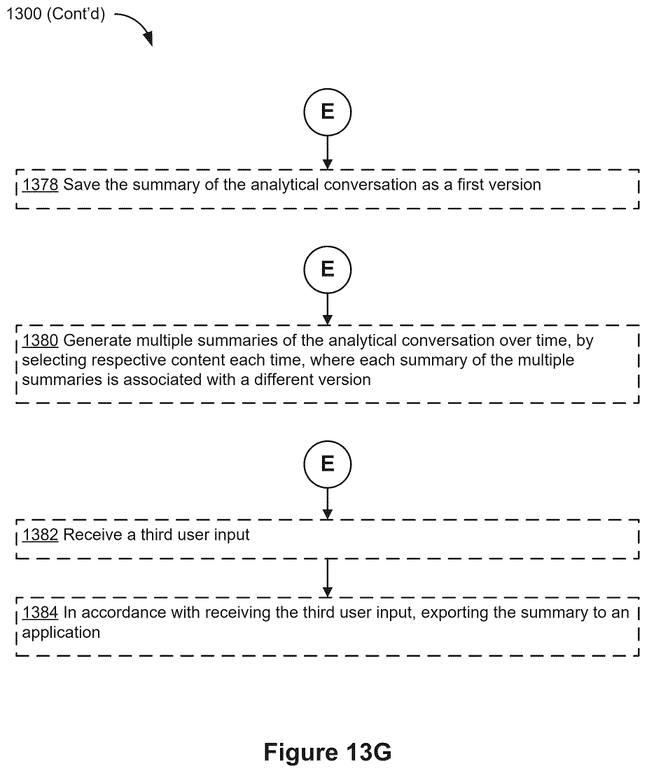

FIGS. 13A to 13G provide a flowchart of an example process for generating adaptable summaries, in accordance with some embodiments. The method 1300 is performed at a computer system (e.g., computing device 200 or computer system 300) that includes one or more processors (e.g., processor(s) 202 or processor(s) 302, and memory (e.g., memory 206 or memory 314). The memory stores one or more programs configured for execution by the one or more processors. In some embodiments, the operations shown in FIGS. 1, 3, 4, 5, 6A-6C, 7A, 7B, 8A-8D, 9A-9C, 10A, 10B, 11A, 11B, and 12A-12Z correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1300 may be combined and/or the order of some operations may be changed.

Referring to FIG. 13A, the computer system receives (1302) first user input specifying a dataset (e.g., dataset 110, datasets/data source 248, raw dataset 1204, or a CSV file) and a chat history (e.g., e.g., chat history 108) of an analytical conversation associated with the dataset.

As used herein, an analytical conversation is a dialogue-driven process where a user (or multiple users) interacts with a system/tool to explore, interpret, and derive insights from data. Analytical conversations are unique for summarization due to their insight-driven content, where the goal is to uncover facts, patterns, or anomalies. They frequently involve mixed modalities, integrating natural language, visualizations, and code snippets, all of which must be synthesized coherently in a summary. Analytical conversations are typically iterative and non-linear, with users refining queries, revisiting previous points, and exploring multiple analysis paths. Effective summarization must preserve the provenance of insights, allowing users to trace back conclusions to their original context, such as queries or datasets. Additionally, summaries must adapt to different audiences, offering technical details for analysts and high-level takeaways for business stakeholders. These conversations also serve as cognitive scaffolding, externalizing thought processes and assumptions that need to be captured to provide context for decisions. In addition, insights are often temporally dependent, building upon previous steps, so summaries must preserve this flow and contextual linkage.

In some embodiments, the chat history includes a record of all messages sent and received in a chat session. In some embodiments, the chat session is between a user and a chat platform regarding the dataset. In some embodiments, the chat platform is an AI conversational platform (e.g., AI chatbot or a LLM, such as ChatGPT) and the chat history is a chat log between the. In some embodiments, the user input specifying the chart history includes user specification of a link (e.g., a URL such as URL 1206) to the chat history.

The computer system, in response to receiving the first user input, extracts (1304) (or causes to be extracted) a plurality of conversational components (e.g., conversational components 233, or analytical conversation component) from the chat history (e.g., related to the dataset). The plurality of conversational components includes a plurality of: (i) one or more conversation turns (e.g., conversation turns 404 or turn pairs), (ii) one or more speech acts (e.g., speech acts 406); (iii) one or more analysis artifacts (e.g., analysis artifacts 408, such as code, visualizations, table, or execution output), (iv) one or more data insights (e.g., data insights 410, such as numerical or statistical results derived from data in the dataset and/or chat history), and (v) one or more conversation threads (e.g., analysis threads 414). In some embodiments, the one or more conversation threads include conversation sub-threads. For example, as illustrated in FIG. 1, the computer system e.g., executing SyncSense) applies content extractor 112 to extract, from the chat history, conversational components such as conversation threads, insights, and speech acts. In some embodiments, content extractor is a LLM (e.g., data processing models 258).

In some embodiments, the computer system applies (1306) a machine learning model (e.g., data processing models 258) to analyze conversation turns in the chat history of analytical conversation to dynamically extract the plurality of conversational components.

In some embodiments, the computer system applies (1308) a set of criteria (e.g., rules) to analyze the chat history of analytical conversation to dynamically extract the plurality of conversational components. For example, in some embodiments, the computer system extracts the content of the chat history and relevant metadata, analyzes the extracted information and categorizes (e.g., classifies or matches) the information to predefined categories/labels according to patterns, text, metadata, and/or context that are identified in the chat history. In some embodiments, the computer system applies rule-based systems or statistical models to perform the extracting and categorizing.

In some embodiments, extracting the one or more speech acts includes categorizing (1310) a respective speech act into one of: fact finding, specific visualization, comparison, domain knowledge, deeper insights, data transformations, recommendations, refinement or follow-up, and debugging. This is illustrated in FIG. 5 and lines 702 in FIG. 7A.

In some embodiments, extracting the one or more data insights includes categorizing (1312) a respective data insight into one or more of: a value, a proportion, a difference, a distribution, a trend, a rank, an aggregation, an association, an extreme, a categorization, and an outlier. This is illustrated in FIG. 8A, lines 802.

In some embodiments, extracting the one or more data insights includes identifying (1312) a respective set of keywords for a respective data insight. This is illustrated in FIG. 8B, lines 804.

In some embodiments, extracting the one or more data insights includes determining (1316) a first portion of the chat history of the analytical conversation from which a respective data insight is derived (e.g., obtained); and extracting the first portion of the chat history of the analytical conversation for display on the user interface. This is illustrated in, for example, FIGS. 8C and 8D at lines 806, 808, and 810.

Referring to FIG. 13B, in some embodiments, extracting the one or more conversation threads includes (i) generating (1318) a summary for each turn-pair in the analytical conversation; (ii) determining one or more sub-threads in the analytical conversation; and (iii) iteratively merging the one or more sub-threads based on their similarity. (ISE, each turn-pair corresponds to a thread, meaning that the number of threads in the conversation should match the number of turns [turn-pairs] in the conversation. ISE, there are multiple sub-threads within a thread. ISE, threads can be grouped together to represent a larger thread.)

In some embodiments, extracting the one or more conversation threads includes applying (1320) a machine learning model (e.g., LLM) to perform the generating, the determining, and the iteratively merging. For example, as discussed in workflow 100 in FIG. 1, in some embodiments, SyncSense prompts the content extractor 112 (e.g., LLM) to summarize each turn-pair in the conversation. It then iteratively merges sub-threads based on their similarity, as determined by the content extractor 112.

In some embodiments, the one or more analysis artifacts include (1322) (i) one or more data visualizations or (ii) one or more data tables. Extracting the one or more analysis artifacts includes executing underlying code of the chat history of the analytical conversation to obtain the one or more data visualizations or the one or more data tables. This is illustrated in FIG. 4.

With continued reference to FIG. 13C, the computer system generates (1324) and displays a user interface (e.g., user interface 130), including rendering the plurality of conversational components as interactive affordances in one or more panels (e.g., chat timeline panel 602, analytical chat contents panel 604, original chat panel 606, and summary editor 608) of the user interface. For example, in some embodiments, the interactive affordances comprise user-interactable icons and a user can select or hover over the icons, as discussed in the examples of FIGS. 12C to 12G. In some embodiments, hovering over threads, speech acts, or insights reveals additional information about the hovered component. In some embodiments, there is a one-to-many correspondence between conversational components and affordances. For example, one conversational component, such as a turn-pair, can be presented by many instances of an icon in the user interface.

In some embodiments, rendering the plurality of conversational components includes arranging (1326) the interactive affordances in the one or more panels of the user interface according to an order in which the conversational components corresponding to the interactive affordances occur in the analytical conversation. For example, in some embodiments, the icons are arranged to follow the natural structure in the conversation. Turns appear in the order they occurred in the original discussion, and each row represents each turn. Likewise, the speech act, insights, and artifacts associated with the turn are also present in the row.

In some embodiments, the chat history of the analytical conversation includes (1328) multiple conversation turns (e.g., turn-taking, where the user and the conversational platform converse one at a time in alternating turns. The one or more panels of the user interface include a chat timeline panel having a plurality of rows, each row representing a respective conversation turn.

In some embodiments, rendering the plurality of conversational components as user-selectable affordances in the one or more panels of the user interface includes rendering (1330) each of the conversational components with a different visual or textual characteristic (e.g., different color, icon, shape).

In some embodiments, the one or more panels of the user interface include a chat timeline panel (e.g., chat timeline panel 602). In some embodiments, the chat timeline panel is configured to display a scrollable (e.g., scrollable in an upward or downward direction) chat timeline of the user's prior interactions with a conversational platform, as illustrated in FIG. 12B.

In some embodiments, the one or more panels of the user interface include an analytical chat contents panel (e.g., analytical chat contents panel 604).

In some embodiments, the one or more panels of the user interface include an original chat panel (e.g., original chat panel 606).

Referring to FIG. 13D, in some embodiments, generating and displaying the user interface includes (1338) generating and displaying the analytical chat content panel, including displaying a plurality of user-selectable headings (e.g., headings 1244) on the analytical chat contents panel, each of the headings (i) corresponding to a respective conversation thread group and (ii) including a respective subset of the plurality of conversational components.

In some embodiments, the method 1300 includes dynamically determining, by the computer system, the headings, including analyzing the conversation turns and identifying patterns, themes, or clusters of related speech acts and insights.

In some embodiments, the computer system receives (1340) a user interaction with a first user-selectable heading of the plurality of user-selectable headings, corresponding to a first conversation thread group. For example, the user interaction with the first user-selectable heading includes user selection of the “>” affordance 1252, as illustrated in FIG. 12J. The computer system, in response to receiving the user interaction, displays (1342) under the first user-selectable heading (e.g., concurrently with the first heading) a list of (e.g., one or more) conversational turn views corresponding to the first conversation thread group. This is illustrated in FIG. 12K. Each of the conversational turn views corresponds to a respective conversational turn and includes associated artifacts and insights for the respective conversational turn. For example, the conversational turn views identify the conversational turns in sequence and are ordered according to an order in which they occur in the analytical conversation.

In some embodiments, the method 1300 further includes in response to receiving a user interaction with a first conversational turn view of the list of conversation turn views, corresponding to a first conversational turn, displaying under the first conversational turn view the associated artifacts and insights for the first conversational turn (e.g., Insights View).

In some embodiments, the computer system receives (1344) user selection of a filter option in the chat timeline panel. For example, the filter option can be a filter option 612 for filtering speech acts (e.g., filter the turns in the conversation), a filter option 614 for filtering insight types, or a filter option 616 for filtering the artifact types (e.g.., the code, data tables, and visualizations). The computer system, in response to receiving user selection of the filter option, concurrently updates (1346) the chat timeline panel and the analytical chat contents panel to display a respective subset, less than all, of the plurality of conversational components.

In some embodiments, generating and displaying the user interface includes displaying (1348) raw contents of the chat history in the original chat panel. In some embodiments, the original chat panel is displayed concurrently with the chat timeline panel and the analytical chat contents panel.

The computer system receives (1350) a second user input. The second input includes a user interaction with a first interactive affordance in the one or more panels of the user interface. In some embodiments, the first interactive affordance has a corresponding first conversational component. In some embodiments, the first interactive affordance is an icon that is displayed on the user interface. In some embodiments, the first interactive affordance is a menu (e.g., a dropdown menu) that is displayed on the user interface. In some embodiments, the user interaction includes user selection of an option that is displayed on the menu. In some embodiments, the first user interactive affordance comprises a text snippet or a graphic that is displayed on the user interface. In some embodiments, the first interactive affordance comprises a metadata description. In some embodiments, the first interactive affordance is displayed with a different visual characteristic (e.g., to visually indicate that it is selectable).

Referring to FIG. 13E, the computer system, in accordance with receiving the second user input, displays (1352) an editing panel (e.g., summary editor panel 608) in the user interface while concurrently displaying the one or more panels of the user interface (the editing panel is different from the one or more panels).

The computer system receives (1354) a user interaction that includes selection of content (e.g., content corresponding to a first conversational component) from the one or more panels of the user interface and placement of the content in the editing panel of the user interface (e.g., via user interactions 131 in FIG. 1 or drag and drop operation 1266 as illustrated in FIG. 12S).

The computer system generates (1356) a summary of the analytical conversation according to the selected content.

In some embodiments, the computer system serializes (1358) the content into a markdown string; inputs the markdown string into a language model application; and receives from the language model application the summary of the analytical conversation.

In some embodiments, generating the summary of the analytical conversation according to the selected content includes inputting (1360) into the language model application (e.g., data processing models 258 or LLM summarizer 134), via the user interface 130, a first value specifying a length of the summary; a second value specifying a level of technical detail for the summary; and a third value specifying a formality of the summary.

For example, as illustrated in FIG. 12X, in some embodiments, the user interface 130 displays menu 1276 that includes options for a user to customize the length, technical details, and formality of the summary.

In some embodiments, the computer system displays (1362) in the user interface a first control element for controlling the length of the summary, a second control element for controlling the level of technical detail for the summary, and a third control element for controlling the formality of the summary. The first, second, and third values are received via the first, second, and third control element, respectively. In some embodiments, each of the control elements specifies a respective range of values the respective parameter for which it controls. In some embodiments, each of the control elements is a slider UI element (e.g., slider bar 1279). For example, as illustrated in FIG. 12X, in some embodiments the user can specify the length (e.g., shorter or longer), technical details (e.g., less technical details or more technical details), and formality (e.g., less formal to more formal) by sliding the respective bars.

The computer system displays (1364) the summary in the user interface.

Referring to FIG. 13F, in some embodiments, the computer system receives (1366) user selection of a second interactive affordance in the chat timeline panel. The computer system, in response to receiving the user selection, displays (1368) a second conversational component corresponding to the second interactive affordance in the analytical chat content panel while continuing to display the chat timeline panel. For example, the user selection of the second interactive affordance comprises a mouse click on the second interactive affordance (e.g., an icon). Clicking on an icon will display the corresponding component in both the Analytical Chat Contents and Original Chat panels, allowing users to navigate directly to the relevant content for more details and trace back to the original conversation) In some embodiments, the computer system receives (1370) a second user interaction that includes selection of a first portion of the raw contents from the original chat panel and placement of the first portion of the raw content in the editing panel of the user interface. The summary of the analytical conversation is generated further in accordance with the first portion of the raw content.

In some embodiments, the computer system receives (1372) user selection of a first interactive affordance in the analytical chat content panel, corresponding to a first conversation turn. the computer system, in response to receiving the user selection, automatically (e.g., without user intervention) navigates (1374) to a first portion of the raw contents of the chat history in the original chat panel, corresponding to the first conversation turn, and displays (1376) the first portion of the raw contents on the user interface in the original chat panel 606. For example, in FIG. 12P, the user clicks on the “To turn 13” button 1258. In response to the user selection, the computing device automatically scrolls (e.g., navigates) the contents of the original chat in the original chat panel 606 to display the relevant part of the conversation corresponding to Turn 13, as illustrated in FIG. 12O.

Referring now to FIG. 13G, in some embodiments, the computer system saves (1378) (e.g., stores) the summary of the analytical conversation as a first version. In some embodiments, the computer system saves the summary of the analytical conversation locally on the computer system. In some embodiments, the computer system saves the summary of the analytical conversation on the cloud.

In some embodiments, the computer system generates (1380) multiple summaries of the analytical conversation over time, by selecting respective (e.g., distinct or partially overlapping) content each time, where each summary of the multiple summaries is associated with a different version. This way, a record of summaries of the analytical conversation is preserved.

In some embodiments, the computer system, after displaying the summary of the analytical conversation in the user interface, receives (1382) a third user input. For example, the third user input can be user selection of a download or export icon, such as the “copy markdown” icon 1286 or the “download” icon 1288 that is illustrated in FIG. 12Z. In accordance with receiving the third user input, the computer system exports (1384) the summary to an application (e.g., application 138 or other applications 240). The application can be a messaging application such as Slack, an email application, a data presentation/communication application such as Microsoft PowerPoint®, Tableau Software®, Microsoft PowerBI®, or a reporting software application.

Although FIGS. 13A to 13G illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments:
(A1) In accordance with some embodiments, a method for generating adaptable data summaries is performed a computer system that includes one or more processors and memory. The method includes (1) receiving first user input specifying a dataset and a chat history of an analytical conversation associated with the dataset; (2) in response to receiving the first user input, extracting a plurality of conversational components from the chat history, the plurality of conversational components including a plurality of: (i) one or more conversation turns, (ii) one or more speech acts; (iii) one or more analysis artifacts, (iv) one or more data insights, and (v) one or more conversation threads; (3) generating and displaying a user interface, including rendering the plurality of conversational components as interactive affordances in one or more panels of the user interface; (4) receiving a second user input, including a user interaction with a first interactive affordance in the one or more panels of the user interface; (5) in accordance with receiving the second user input, displaying an editing panel in the user interface while concurrently displaying the one or more panels of the user interface; (6) receiving a user interaction that includes selection of content from the one or more panels of the user interface and placement of the content in the editing panel of the user interface; (7) generating a summary of the analytical conversation according to the selected content; and (8) displaying the summary in the user interface.
(A2) In some embodiments of A1, extracting the plurality of conversational components from the chat history includes applying a machine learning model to analyze conversation turns in the chat history of analytical conversation to dynamically extract the plurality of conversational components.
(A3) In some embodiments of A1 or A2, extracting the plurality of conversational components from the chat history includes applying a set of criteria to analyze the chat history of analytical conversation to dynamically extract the plurality of conversational components.
(A4) In some embodiments of any of A1-A3, extracting the one or more speech acts includes categorizing a respective speech act into one of: fact finding, specific visualization, comparison, domain knowledge, deeper insights, data transformations, recommendations, refinement or follow-up, and debugging.
(A5) In some embodiments of any of A1-A4, extracting the one or more data insights includes categorizing a respective data insight into one or more of: a value, a proportion, a difference, a distribution, a trend, a rank, an aggregation, an association, an extreme, a categorization, and an outlier.
(A6) In some embodiments of any of A1-A5, extracting the one or more data insights includes identifying a respective set of keywords for a respective data insight.
(A7) In some embodiments of any of A1-A6, extracting the one or more data insights includes determining a first portion of the chat history of the analytical conversation from which a respective data insight is derived; and extracting the first portion of the chat history of the analytical conversation for display on the user interface.
(A8) In some embodiments of any of A1-A7 extracting the one or more conversation threads includes: (i) generating a summary for each turn-pair in the analytical conversation; (ii) determining one or more sub-threads in the analytical conversation; and (iii) iteratively merging the one or more sub-threads based on their similarity.
(A9) In some embodiments of A8, extracting the one or more conversation threads includes applying a machine learning model to perform the generating, the determining, and the iteratively merging.
(A10) In some embodiments of any of A1-A9, the one or more analysis artifacts include (i) one or more data visualizations or (ii) one or more data tables; and extracting the one or more analysis artifacts includes executing underlying code of the chat history of the analytical conversation to obtain the one or more data visualizations or the one or more data tables.
(A11) In some embodiments of any of A1-A10, rendering the plurality of conversational components includes arranging the interactive affordances in the one or more panels of the user interface according to an order in which the conversational components corresponding to the interactive affordances occur in the analytical conversation.
(A12) In some embodiments of any of A1-A11, the chat history of the analytical conversation includes multiple conversation turns; and the one or more panels of the user interface include a chat timeline panel having a plurality of rows, each row representing a respective conversation turn.
(A13) In some embodiments of any of A1-A12, rendering the plurality of conversational components as user-selectable affordances in the one or more panels of the user interface includes rendering each of the conversational components with a different visual or textual characteristic.
(A14) In some embodiments of any of A1-A13, the one or more panels of the user interface include a chat timeline panel and an analytical chat contents panel; and the method includes: in response to receiving user selection of a second interactive affordance in the chat timeline panel, displaying a second conversational component corresponding to the second interactive affordance in the analytical chat contents panel while continuing to display the chat timeline panel.
(A15) In some embodiments of any of A1-A14, the one or more panels of the user interface include an analytical chat contents panel; and generating and displaying the user interface includes generating and displaying the analytical chat contents panel, including displaying a plurality of user-selectable headings on the analytical chat contents panel, each of the headings (i) corresponding to a respective conversation thread group and (ii) including a respective subset of the plurality of conversational components.
(A16) In some embodiments of A15, the method includes, in response to receiving a user interaction with a first user-selectable heading of the plurality of user-selectable headings, corresponding to a first conversation thread group: displaying, under the first user-selectable heading, a list of conversational turn views corresponding to the first conversation thread group, each of the conversational turn views corresponding to a respective conversational turn and including associated artifacts and insights for the respective conversational turn.
(A17) In some embodiments of any of A1-A16, the one or more panels of the user interface include a chat timeline panel and an analytical chat contents panel; and the method includes, in response to receiving user selection of a filter option in the chat timeline panel, concurrently updating the chat timeline panel and the analytical chat contents panel to display a respective subset, less than all, of the plurality of conversational components.
(A18) In some embodiments of any of A1-A17, the one or more panels of the user interface include an original chat panel; and generating and displaying the user interface includes displaying raw contents of the chat history in the original chat panel.
(A19) In some embodiments of A18, the method further includes: receiving a second user interaction that includes selection of a first portion of the raw contents from the original chat panel and placement of the first portion of the raw content in the editing panel of the user interface, wherein the summary of the analytical conversation is generated further in accordance with the first portion of the raw content.
(A20) In some embodiments of A18 or A19, the one or more panels of the user interface further include an analytical chat contents panel; and the method includes, in response to user selection of a first interactive affordance in the analytical chat contents panel, corresponding to a first conversation turn: (i) automatically navigating to a first portion of the raw contents of the chat history in the original chat panel, corresponding to the first conversation turn; and (ii) displaying the first portion of the raw contents on the user interface.
(A21) In some embodiments of any of A1-A20, generating the summary of the analytical conversation according to the selected content includes: (i) serializing the content into a markdown string; (ii) inputting the markdown string into a language model application; and (iii) receiving from the language model application the summary of the analytical conversation.
(A22) In some embodiments of A21, the method further includes inputting into the language model application one or more of: (i) a first value specifying a length of the summary; (ii) a second value specifying a level of technical detail for the summary; and (iii) a third value specifying a formality of the summary.
(A23) In some embodiments of A22, the method further includes displaying in the user interface one or more of: a first control element for controlling the length of the summary, a second control element for controlling the level of technical detail for the summary, and a third control element for controlling the formality of the summary, wherein the first, second, and third values are received via the first, second, and third control elements, respectively.
(A24) In some embodiments of any of A1-A23, the method further includes saving the summary of the analytical conversation as a first version.
(A25) In some embodiments of any of A1-A24, the method further includes generating multiple summaries of the analytical conversation over time, by selecting respective content each time, wherein each summary of the multiple summaries is associated with a different version.
(A26) In some embodiments of any of A1-A25, the method further includes, after displaying the summary of the analytical conversation in the user interface: in accordance with receiving a third user input, exporting the summary to an application.
(B1) In accordance with some embodiments, a computer system includes one or more processors and memory coupled to the one or more processors. The memory stores instructions that, when executed by the one or more processors, cause the computer system to perform the method of any of A1-A26.
(C1) In accordance with some embodiments, a computer-readable storage medium stores one or more programs that, when executed by one or more processors of a computing device, cause the computing device to perform the method of any of A1-A26.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining”can include resolving, selecting, choosing, establishing and the like.

The phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or embodiments.

As used herein, the term “and/or” encompasses any combination of listed elements. For example, “A, B, and/or C” entails each of the following possibilities: A only, B only, C only, A and B without C, A and C without B, B and C without A, and a combination of A, B, and C.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for generating adaptable data summaries, comprising:
a computer system that includes one or more processors and memory:
receiving first user input specifying a dataset and a chat history of an analytical conversation associated with the dataset;
in response to receiving the first user input:
extracting a plurality of conversational components from the chat history, the plurality of conversational components including a plurality of: (i) one or more conversation turns, (ii) one or more speech acts; (iii) one or more analysis artifacts, (iv) one or more data insights, and (v) one or more conversation threads;
generating and displaying a user interface, including rendering the plurality of conversational components as interactive affordances in one or more panels of the user interface;
receiving a second user input, including a user interaction with a first interactive affordance in the one or more panels of the user interface;
in accordance with receiving the second user input, displaying an editing panel in the user interface while concurrently displaying the one or more panels of the user interface;
receiving a user interaction that includes selection of content from the one or more panels of the user interface and placement of the content in the editing panel of the user interface;
generating a summary of the analytical conversation according to the selected content; and
displaying the summary in the user interface.

2. The method of claim 1, wherein extracting the plurality of conversational components from the chat history includes:
applying a machine learning model to analyze conversation turns in the chat history of analytical conversation to dynamically extract the plurality of conversational components.

3. The method of claim 1, wherein extracting the plurality of conversational components from the chat history includes applying a set of criteria to analyze the chat history of analytical conversation to dynamically extract the plurality of conversational components.

4. The method of claim 1, wherein extracting the one or more speech acts includes categorizing a respective speech act into one of: fact finding, specific visualization, comparison, domain knowledge, deeper insights, data transformations, recommendations, refinement or follow-up, and debugging.

5. The method of claim 1, wherein extracting the one or more data insights includes categorizing a respective data insight into one or more of: a value, a proportion, a difference, a distribution, a trend, a rank, an aggregation, an association, an extreme, a categorization, and an outlier.

6. The method of claim 1, wherein extracting the one or more data insights includes identifying a respective set of keywords for a respective data insight.

7. The method of claim 1, wherein extracting the one or more data insights includes:
determining a first portion of the chat history of the analytical conversation from which a respective data insight is derived; and
extracting the first portion of the chat history of the analytical conversation for display on the user interface.

8. The method of claim 1, wherein:
the one or more panels of the user interface include a chat timeline panel and an analytical chat contents panel; and
the method includes:
in response to receiving user selection of a second interactive affordance in the chat timeline panel, displaying a second conversational component corresponding to the second interactive affordance in the analytical chat contents panel while continuing to display the chat timeline panel.

9. A computer system, comprising:
one or more processors; and
memory coupled to the one or more processors, the memory storing one or more programs configured to be executed by the one or more processors, the one or more programs including instructions for:
receiving first user input specifying a dataset and a chat history of an analytical conversation associated with the dataset;
in response to receiving the first user input:
extracting a plurality of conversational components from the chat history, the plurality of conversational components including a plurality of: (i) one or more conversation turns, (ii) one or more speech acts; (iii) one or more analysis artifacts, (iv) one or more data insights, and (v) one or more conversation threads;
generating and displaying a user interface, including rendering the plurality of conversational components as interactive affordances in one or more panels of the user interface;
receiving a second user input, including a user interaction with a first interactive affordance in the one or more panels of the user interface;
in accordance with receiving the second user input, displaying an editing panel in the user interface while concurrently displaying the one or more panels of the user interface;
receiving a user interaction that includes selection of content from the one or more panels of the user interface and placement of the content in the editing panel of the user interface;
generating a summary of the analytical conversation according to the selected content; and
displaying the summary in the user interface.

10. The computer system of claim 9, wherein the instructions for extracting the one or more conversation threads include instructions for:
generating a summary for each turn-pair in the analytical conversation;
determining one or more sub-threads in the analytical conversation; and
iteratively merging the one or more sub-threads based on their similarity.

11. The computer system of claim 9, wherein:
the one or more analysis artifacts include (i) one or more data visualizations or (ii) one or more data tables; and
the instructions for extracting the one or more analysis artifacts include instructions for executing underlying code of the chat history of the analytical conversation to obtain the one or more data visualizations or the one or more data tables.

12. The computer system of claim 9, wherein the instructions for rendering the plurality of conversational components include instructions for:
arranging the interactive affordances in the one or more panels of the user interface according to an order in which the conversational components corresponding to the interactive affordances occur in the analytical conversation.

13. The computer system of claim 9, wherein:
the chat history of the analytical conversation includes multiple conversation turns; and
the one or more panels of the user interface include a chat timeline panel having a plurality of rows, each row representing a respective conversation turn.

14. The computer system of claim 9, wherein the instructions for rendering the plurality of conversational components as user-selectable affordances in the one or more panels of the user interface include instructions for rendering each of the conversational components with a different visual or textual characteristic.

15. A non-transitory computer-readable storage medium storing one or more programs, the one or more programs comprising instructions that, when executed by a computer system, cause the computer system to:
receive first user input specifying a dataset and a chat history of an analytical conversation associated with the dataset;
in response to receiving the first user input:
extract a plurality of conversational components from the chat history, the plurality of conversational components including a plurality of: (i) one or more conversation turns, (ii) one or more speech acts; (iii) one or more analysis artifacts, (iv) one or more data insights, and (v) one or more conversation threads;
generate and display a user interface, including render the plurality of conversational components as interactive affordances in one or more panels of the user interface;
receive a second user input, including a user interaction with a first interactive affordance in the one or more panels of the user interface;
in accordance with receiving the second user input, display an editing panel in the user interface while concurrently displaying the one or more panels of the user interface;
receive a user interaction that includes selection of content from the one or more panels of the user interface and placement of the content in the editing panel of the user interface;
generate a summary of the analytical conversation according to the selected content; and
display the summary in the user interface.

16. The non-transitory computer-readable storage medium of claim 15, wherein:
the one or more panels of the user interface include an analytical chat contents panel; and
generating and displaying the user interface includes generating and displaying the analytical chat contents panel, including displaying a plurality of user-selectable headings on the analytical chat contents panel, each of the user-selectable headings (i) corresponding to a respective conversation thread group and (ii) including a respective subset of the plurality of conversational components.

17. The non-transitory computer-readable storage medium of claim 15, wherein:
the one or more panels of the user interface include a chat timeline panel and an analytical chat contents panel; and
the one or more programs comprise instructions that, when executed by the computer system, cause the computer system to:
in response to receiving user selection of a filter option in the chat timeline panel, concurrently update the chat timeline panel and the analytical chat contents panel to display a respective subset, less than all, of the plurality of conversational components.

18. The non-transitory computer-readable storage medium of claim 15, wherein:
the one or more panels of the user interface include an original chat panel; and
generating and displaying the user interface includes displaying raw contents of the chat history in the original chat panel.

19. The non-transitory computer-readable storage medium of claim 15, wherein generating the summary of the analytical conversation according to the selected content includes:
serializing the content into a markdown string;
inputting the markdown string into a language model application; and
receiving from the language model application the summary of the analytical conversation.

20. The non-transitory computer-readable storage medium of claim 15, wherein the one or more programs comprise instructions that, when executed by the computer system, cause the computer system to:
after displaying the summary of the analytical conversation in the user interface:
in accordance with receiving a third user input, export the summary to an application.
